(19) United States
(12) Patent Application Publication
(10) Pub. No.: US 2022/0084086 A1
(43) Pub. Date: Mar. 17, 2022

(54) METHODS, SYSTEMS, APPARATUSES, AND DEVICES FOR FACILITATING AUDITING TOLLING ASSOCIATED WITH ROUTES

(71) Applicant: VeriToll, LLC, Ashburn, VA (US)

(72) Inventors: Joseph C. Silva, Las Vegas, NV (US); Miguel A. Calles, La Habra, CA (US); David Ji Kim, Frisco, TX (US)

(21) Appl. No.: 17/475,052

(22) Filed: Sep. 14, 2021

Related U.S. Application Data
(60) Provisional application No. 63/077,945, filed on Sep. 14, 2020.

(51) Int. Cl. G06Q 30/02; G01C 21/36; G06K 9/00; G07C 5/00

(52) U.S. Cl. CPC G06Q 30/0284; G06Q 30/0207; G07C 5/008; G01C 21/3697; G06K 9/00798; G01C 21/3679

(57) ABSTRACT

A method and system for facilitating auditing tolling associated with routes is provided. The method comprises receiving a request from a user device, receiving vehicle data from a vehicle device associated with a vehicle used by a user for making a trip using a route, analyzing the vehicle data, verifying the vehicle for the trip based on the analyzing, identifying the route based on the verifying and the request, retrieving toll pricing sign information of a toll pricing sign displayed on the route based on the identifying, transmitting the toll pricing sign information to the user device, receiving a response corresponding to the toll pricing sign encountered by the user while driving the vehicle on the route from the user device, generating an audit data of the route based on a user identifier, the vehicle data, the route, the response, and the toll pricing information, and storing the audit data.

The current application claims a priority to the U.S. Provisional Patent application Ser. No. 63/077,945 filed on Sep. 14, 2020.

### TECHNICAL FIELD

Generally, the present disclosure relates to the field of data processing. More specifically, the present disclosure relates to methods, systems, apparatuses, and devices for facilitating auditing tolling associated with routes.

### BACKGROUND

The field of data processing is technologically important to several industries, business organizations, and/or individuals.

Existing techniques for facilitating auditing tolling associated with routes are deficient with regard to several aspects. For instance, current technologies do not provide a way to audit the toll systems. Furthermore, current technologies do not provide an incentivized way to audit the toll systems.

Therefore, there is a need for methods, systems, apparatuses, and devices for facilitating auditing tolling associated with routes that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating auditing tolling associated with routes, in accordance with some embodiments. The method may include a step of receiving, using a communication device, one or more request associated with one or more trip from one or more user device associated with one or more user. Further, the one or more request may include one or more user identifier associated with the one or more user. Further, the method may include a step of receiving, using the communication device, one or more vehicle data from one or more vehicle device associated with one or more vehicle used by the one or more user for making the one or more trip using one or more route. Further, the one or more vehicle data may include one or more vehicle identifier associated with the one or more vehicle. Further, the method may include a step of analyzing, using a processing device, the one or more vehicle data. Further, the method may include a step of verifying, using the processing device, the one or more vehicle for the one or more trip based on the analyzing of the one or more vehicle data. Further, the method may include a step of identifying, using the processing device, the one or more route for auditing the tolling based on the verifying of the one or more vehicle and the one or more request. Further, the one or more user drives the one or more vehicle on the one or more route for auditing the tolling associated with the one or more route during the one or more trip. Further, the method may include a step of retrieving, using a storage device, one or more toll pricing sign information of one or more toll pricing sign displayed on the one or more route based on the identifying. Further, the method may include a step of transmitting, using the communication device, the one or more toll pricing sign information to the one or more user device. Further, the method may include a step of receiving, using the communication device, one or more response corresponding to the one or more toll pricing sign encountered by the one or more user while driving the one or more vehicle on the one or more route during the one or more trip from the one or more user device. Further, the method may include a step of generating, using the processing device, one or more audit data of the one or more route based on the one or more user identifier, the one or more vehicle data, the one or more route, the one or more response, and the one or more toll pricing information. Further, the method may include a step of storing, using the storage device, the one or more audit data of the one or more route.

Further disclosed herein is a system for facilitating auditing tolling associated with routes, in accordance with some embodiments. The system may include a communication device, a processing device, and a storage device. Further, the communication device may be configured for performing a step of receiving one or more request associated with one or more trip from one or more user device associated with one or more user. Further, the one or more request may include one or more user identifier associated with the one or more user. Further, the communication device may be configured for performing a step of receiving one or more vehicle data from one or more vehicle device associated with one or more vehicle used by the one or more user for making the one or more trip using one or more route. Further, the one or more vehicle data may include one or more vehicle identifier associated with the one or more vehicle. Further, the communication device may be configured for performing a step of transmitting one or more toll pricing sign information to the one or more user device. Further, the communication device may be configured for performing a step of receiving one or more response corresponding to one or more toll pricing sign encountered by the one or more user while driving the one or more vehicle on the one or more route during the one or more trip from the one or more user device. The processing device may be communicatively coupled with the communication device. Further, the processing device may be configured for performing a step of analyzing the one or more vehicle data. Further, the processing device may be configured for performing a step of verifying the one or more vehicle for the one or more trip based on the analyzing of the one or more vehicle data. Further, the processing device may be configured for performing a step of identifying the one or more route for auditing the tolling based on the verifying of the one or more vehicle and the one or more request. Further, the one or more user drives the one or more vehicle on the one or more route for auditing the tolling associated with the one or more route during the one or more trip. Further, the processing device may be configured for performing a step of generating one or more audit data of the one or more route based on the one or more user identifier, the one or more vehicle data, the one or more route, the one or more response, and the one or more toll pricing information. The storage device may be communicatively coupled with the processing device. Further, the storage device may be configured for performing a step of retrieving the one or more toll pricing sign information of the one or more toll pricing sign displayed on the one or more route based on the identifying. Further, the storage device may be configured for performing a step of storing the one or more audit data of the one or more route.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating auditing tolling associated with routes, in accordance with some embodiments.

FIG. 4 is a continuation flow chart of FIG. 3.

FIG. 5 is a flow chart of the method for facilitating auditing tolling associated with routes in which the method may include storing, using the storage device, the one or more route, in accordance with some embodiments.

FIG. 6 is a flow chart of a method for facilitating auditing tolling associated with routes in which the method may include transmitting one or more of the one or more indication of the passing of the one or more point of interest (POI) and the one or more time window to one or more third user device, in accordance with some embodiments.

FIG. 7 is a flow chart of a method for facilitating auditing tolling associated with routes in which the method may include transmitting a health to the one or more third user device, in accordance with some embodiments.

FIG. 8 is a flow chart of a method for facilitating auditing tolling associated with routes in which the method may include transmitting the one or more specific audit data to the one or more second user device, in accordance with some embodiments.

FIG. 9 is a flow chart of a method for facilitating auditing tolling associated with routes in which the method may include transmitting the one or more incentive to one or more specific user device associated with the one or more specific user, in accordance with some embodiments.

FIG. 10 is a flow chart of a method for facilitating auditing tolling associated with routes in which the method may include transmitting the discrepancy report to one or more tolling agency device associated with the one or more tolling agency, in accordance with some embodiments.

FIG. 11 is a block diagram of a system for facilitating auditing tolling associated with routes, in accordance with some embodiments.

FIG. 12 is a flowchart of a method for facilitating managing of toll systems, in accordance with some embodiments.

FIG. 13 is a flow diagram of a method for facilitating managing of toll systems using a Tolling Platform, in accordance with some embodiments.

FIG. 14 is an illustration describing a calculation method of a route for facilitating active, passive, and continuous GPS trip tracking and vehicle identification, in accordance with some embodiments.

FIG. 15 is a flow diagram of a method for facilitating active, passive, and continuous GPS trip tracking and vehicle identification, in accordance with some embodiments.

FIG. 16 is a flow diagram of a method for facilitating managing of toll systems, in accordance with some embodiments.

FIG. 17 is a flow diagram of a method for facilitating managing of toll systems, in accordance with some embodiments.

FIG. 18 is a flow diagram of a method for facilitating managing of toll systems, in accordance with some embodiments FIG. 19 is a flow diagram of a method for facilitating managing of toll systems, in accordance with some embodiments.

FIG. 20 is illustrations describing a calculation method of a route for facilitating active, passive, and continuous GPS trip tracking and vehicle identification, in accordance with some embodiments.

FIG. 21 is a block diagram of a system for facilitating managing of toll systems, in accordance with some embodiments.

FIG. 22 is a block diagram of a system for facilitating managing of toll systems, in accordance with some embodiments.

FIG. 23 is a screenshot of a user interface of the software platform associated with the disclosed system for facilitating auditing tolling associated with routes, in accordance with some embodiments.

FIG. 24 is a screenshot of a user interface of the software platform associated with the disclosed system for facilitating auditing tolling associated with routes, in accordance with some embodiments.

FIG. 25 is a screenshot of a user interface of the software platform associated with the disclosed system for facilitating auditing tolling associated with routes, in accordance with some embodiments.

FIG. 26 is a screenshot of a user interface of the software platform associated with the disclosed system for facilitating auditing tolling associated with routes, in accordance with some embodiments.

FIG. 27 is a screenshot of a user interface of the software platform associated with the disclosed system for facilitating auditing tolling associated with routes, in accordance with some embodiments.

FIG. 28 is a screenshot of a user interface of the software platform associated with the disclosed system for facilitating auditing tolling associated with routes, in accordance with some embodiments.

FIG. 29 is a screenshot of a user interface of the software platform associated with the disclosed system for facilitating auditing tolling associated with routes, in accordance with some embodiments.

FIG. 30 is a screenshot of a user interface of the software platform associated with the disclosed system for facilitating auditing tolling associated with routes, in accordance with some embodiments.

FIG. 31 is a screenshot of a user interface of the software platform associated with the disclosed system for facilitating auditing tolling associated with routes, in accordance with some embodiments.

FIG. 32 is a screenshot of a user interface of the software platform associated with the disclosed system for facilitating auditing tolling associated with routes, in accordance with some embodiments.

FIG. 33 is a screenshot of a user interface of the software platform associated with the disclosed system for facilitating auditing tolling associated with routes, in accordance with some embodiments.

FIG. 34 is a screenshot of a user interface of the software platform associated with the disclosed system for facilitating auditing tolling associated with routes, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating auditing tolling associated with routes, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and an environmental variable sensor (e.g. temperature sensor, humidity sensor, pressure sensor, etc.) associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating auditing tolling associated with routes. Further, the disclosed system may be configured for facilitating the managing of toll systems. Further, a tolling application, an exemplary embodiment of the disclosed system may be configured for active, passive, and continuous GPS trip tracking and vehicle identification. Further, the disclosed system may verify the driver is using the same vehicle during each test trip. Since a driver might decide to change a vehicle, but forget to notify the test administrator of this change. Upon registering for a test event, the driver may enable Bluetooth. Further, the disclosed system may be associated with a software platform. Further, the tolling application may attempt to read the vehicle's Bluetooth signal. Upon a successful read, the tolling application may record the details about the vehicle and link it to a vehicle profile. Whenever a driver starts a trip, tolling application may use the vehicle's Bluetooth signal to confirm the identity of the vehicle.

Further, the disclosed system may be configured for Dynamic Pricing Auditing. Further, the disclosed system may be configured to audit the prices shown on the pricing signs before entering the toll road. If the pricing sign is down or displaying the incorrect price, the toll road operator is obligated to refund the entire trip price to the customer. This means thousands of dollars of revenue lost per minute. Further, tolling application drivers can audit the pricing signs for the trips they are testing. They may enter the price they saw at the sign at the beginning of the end of their trip. The software platform (such as a software application, a website, etc.) may display a picture of a pricing sign to verify whether they saw that same sign and price before entering the toll road. The application may ask to enter the prices they saw on the sign, confirm the picture matches what they saw, or both.

Further, the disclosed system may be associated with tolling application GPS Data to Trip Route. Further, the disclosed system may be configured to test specific trip routes. For testing, trip routes are manually drawn or adjust turn-by-turn directions to get the desired route. Further, turn-by-turn directions do not always exist. Further, some conventional systems do not complete direction, road data, or satellite imagery in some cases. Further, the drivers use the tolling application to collect GPS data or purchase actual GPS data from a third party. Further, the systems may use all the GPS data to calculate a line that defines the actual route.

Further, the disclosed system may be configured for facilitating passive tracking. Further, the disclosed system may be configured to facilitate driving on specific trip routes several times and overall, several days, weeks, months, and even years. Since there might not be sufficient drivers or budget to meet the need. Therefore, anyone using the tolling application is eligible to test trip routes. Further, the driver may simply drive with the application open. After they finish driving, the tolling application may look at their GPS trip data and compare it against all the trip routes that clients want to be tested. If the driver (or user) drove along a trip route, they may get credit for testing the trip route. The driver (or client) gets only the relevant GPS data.

Further, the disclosed system may be associated with tolling application Point of Interest Check-Ins. Further, the disclosed system may determine points of interest (POIs) to know when a driver has passed. A POI may be a waypoint, a tolling gantry, a toll booth, etc. They want to know the time window when the driver has passed the POI to verify against their system records. Further, the client cannot confirm whether the POI timestamp in their system is accurate without external validation. Further, a client uses the disclosed system to specify POIs in the tolling application. Further, the tolling application may use GPS data to calculate the time window when a driver passed the POI. The aggregation of POI check-ins from various drivers may provide a health indicator for a tolling road gantry. Gantries with a low quantity of POI check-in or a high quantity of missed external validations in the tolling systems may be an indicator of faulty equipment.

Further, the disclosed system may audit toll road equipment by providing an independent record regarding a trip taken on a toll road. Further, the driver uses a smartphone application to take trips or any software and hardware that sends GPS information to the system. Further, the application and the website may track the GPS information and record this against the trips. Further, a toll road system associated with the disclosed system may corroborate their toll road records against records to verify their equipment is properly working. Further, the disclosed system may use a smartphone auditing application, databases to record trip data, and a web application. Further, a web application associated with the disclosed system may be used to set up and monitor trips, and to obtain the trip data. The web application enables users to create test trips and saves them to the database. Further, a mobile application associated with the disclosed system enables drivers to view their assigned trips stored in the database. The mobile application generates GPS location and trip status and stores them in the database. The web application enables drivers to view the GPS data and trip status stored in the database. The web application processes the GPS data to generate other meaningful test data and stores that new data in the database.

Further, the disclosed system is associated with toll systems and associated systems. Sensor data other than location may be received from both mobile devices and toll systems. E.g. any vehicle-mounted sensor (E.g. dashcam) may also be tapped and transmitted to the invention. The mobile device may be paired with the car using Bluetooth™ and accordingly by using Bluetooth transceivers at the gantry of the toll system, monitoring may be performed. An incentive for users to download the application onto their phone and/or verifying information is that they get discounts on toll charges and get notified if they have been wrongly billed. Using either a mobile camera or cameras mounted on the vehicle to capture toll-related information (e.g. sign board displaying toll charges) and automatically extracting and distributing this information to other users for validation/consumption etc.

Further, customers may use the tolling application to verify their assets and back-office systems are properly capturing tolls. The customer may assign a test administrator who will organize test trips to verify the different toll points along the asset using the tolling application administrator interface. Further, the tolling application may make the test trips available to drivers who will drive the designated test routes. The drivers are part of a group that gets crowdsourced to drive the test trips. The drivers use the tolling mobile app, called “HUSLN Drive,” to accept a trip, report their trip status, and send position updates depicting their actual route. The test administrator uses the tolling application administrator interface to collect the test results and prepare a test report. The customer may use the tolling application customer portal to collect the test data from the test report and compare it against the data reported by the asset and back-office system. The customer may update the test results in the tolling application customer portal per the results of the analysis. Ultimately, the tolling application allows the customers to perform numerous test trips without hiring drivers, but by leveraging the crowd.

The tolling application may be organized into major systems:
Test management service—A web-based interface for creating the test plans and test trips, collecting test trip data, and creating customer-facing test reports
Test probes—A mobile app for accepting and completing test trips
Driver management service—A web-based interface for assigning drivers to test trips and tracking their current geolocation and trip status.
Geolocation service—A system for processing geolocation data from the test probes

Further, users associated with account management services may include system administrators, Test administrators, Test drivers, and Client test analysts. Further, users associated with test management services may include test administrators and client test analysts. Further, users associated with test probes may include Test drivers. Further, users associated with driver management services may include test administrators and test drivers.

Further, the Account Management Service may manage all types of users and their login sessions, allow the system administrator to invite users to specific roles, interface with the other services for authentication and re-authentication. Further, the system Administrator UI may be an application with the Test Administrator and Client UIs. Further, the system administrator UI interfaces with the Account Management Services and allows the user to create other users types and manage user accounts.

Further, the Test Administrator UI may be an application with the System Administrator and Client UIs. Further, the Test Administrator UI interfaces with the Test Management Service and allows the user to create test plans, specify the customer, assign specific test drivers or crowdsource it, i.e. make it available to any driver in the located near the test trip locations crowdsource, and specify the earliest start and end date. Further, the Test Administrator UI interfaces with the Test Management Service and allows the user to create test trips for a test plan by drawing the test route start and end locations, drawing geo-fences as points of interest, these are typically the physical tolling gantry locations, specifying the start and end date for a test trip, specifying the number of times a test trip is driven, and specifying the estimated trip duration. Further, the tolling application backend can also estimate it based on the start and end location. Further, the Test Administrator UI interfaces with the Test Management Service and allows the user to view the real-time status of the test trips, view the real-time locations of all the drivers per test plan, view the test trip results as a map showing the drive path, the trip duration with the start and end time, duration driving vs. duration stopped/idle, whether the points of interest, start and end locations were triggered, and license plates of the drivers to avoid charging them tolls. Further, the Test Administrator UI interfaces with the Test Management Service and allows the user to view the estimated prices for each test trip and the cumulative prices depending on the customer pricing plan, make the test plan live (if it is in a draft state), close the test plan, create a report for the client, and make the test report accessible as a PDF, Word document, or JSON.

Further, the Client UI (stretch goal) may be an application with the Test Administrator and System Administrator UIs. Further, the Client UI (stretch goal) may interface with Account Management service for account registration and login, Interfaces with the Test Management Service and allows the user to register and login, view, and download test trips, and create an API key for their Back Office System to query the test data.

Further, the tolling application Backend hosts the System Administrator, Test Administrator, and Client UIs and hosts any infrastructure and platforms to support the Test Management and driver Management services.

Further, the test Management Service may set the GPS polling frequency. Further, the test Management Service may provide HTTP endpoints for Test driver mobile app to perform its functions, Test administrator to perform its functions, and Client to get the test report via an API key.

Further, the driver management service may allow the test administrator to assign specific drivers to test trips, allow the service to automatically assign drivers, view the test trips schedule, view the driver schedules, and view the real-time status of all the active test drivers. Further, the driver Management Service may allow the test driver to accept, schedule, start and complete test trips. Further, the driver Management Service may provide HTTP endpoints for the test driver mobile app to perform its functions and the test administrator to perform its functions.

Further, the test probe may allow the test drivers to register, login, view available test trips, and accept test trips. Further, if the test trip is planned for a future time, it is added to a schedule. Further, if the test trip is within the start and end dates, can do one of start the trip and schedule the trip. Further, the test probe may organize the schedule of future test trips, report when a test trip has started, report when a test trip is complete, and view their earnings (stretch goal). Further, the test probe may be a mobile app and may run on Android and iOS mobile apps (and using the application code). Further, the test probe may interface with the Account Management service to perform account registration and login. Further, the test probe may interface with the Driver Management Service to accept, schedule, start, and complete test trips, and show the test trip drive schedule by getting the information from the tolling application backend. Further, the test probe may interface with the Test Management Service to get the polling frequency at the start of every trip, send test trip status updates, and send geo-position data per the polling frequency as floats, e.g. 43.9999, −120.9999

Further, the tolling platform provides end-to-end toll road auditing. The platform allows users to schedule trips, execute trips, record GPS information, and provide independent toll road records. The toll road operator can use these records to perform an independent audit of the toll road data.

Further, the tolling platform (or platform) may consist of at least four major subsystems: a web application, the application backend, a mobile app (test probe), and external sensors. The web application and mobile app use the application backend to read and write data. Furthermore, the application backend can interface with the toll road operator's back-office system. Furthermore, external sensors can provide images, video, electrical signal data, radio frequency signal data, and any other data that can create an audit data.

Furthermore, instances of the platform may be deployed for each client. Each client's data is isolated from the client's data because there are no shared subsystems. For example, one client's instance has separate databases and there is no connection between another client's instance and its database. An instance's web application and application backend are isolated from those of other instances. The mobile app supports logging into any instance and only one instance at a time. The mobile application does not share information between instances and does not save the data onto the phone or may temporarily save data on the phone until it is successfully saved to the database. This isolated, multi-tenant architecture improves the security and privacy of the clients. Further, the platform may be initially designed to support use cases from the point of view of test administrators, test analysis, and test drivers.

When a client signs up with the tolling application, we set up their tolling application instance. We install the web application and application backend. Further, the disclosed system may be configured both to allow the client to create mobile app user accounts for the test drivers to use when they download the mobile app. When the instance is set up, the client can log in and start creating their test trips. Further, the client may define the test trips to be driven. To create test trips, the client may specify the trip name and draw the trip waypoints, or specify the start and end addresses. Further, the client may now use this trip to assign multiple trip plans and drivers. The client will create as many trips that need testing. He/she will need to create a schedule to test all the trips. The client will create a trip plan. The trip plan allows the client to assign multiple drivers to trips and assign multiple runs. For example, trip plan A might have the following assignments:
Trip A is assigned to Drivers A & B. This trip is scheduled for two-time windows
Trip B is assigned to Drivers B & C. This trip is scheduled for one-time window.

Further, trip A may be executed four times: twice by Driver A and twice by Driver B. Trip B will be executed two times: once by Driver B and once by Driver C.

When the client finishes setting up the trip plan, the platform may generate the trip assignments and they become visible in the respective driver's mobile app.

Further, the disclosed system may be configured for executing test trips. Further, the driver will see a list of assigned trips on their first screen; see the previous screen capture. The trips are ordered by the schedule; the earliest scheduled date is listed first. The driver will select the desired trip and will see the trip details. The driver will see the visual route, any notes, the trip status, and additional information. The driver will start the trip to start recording GPS data.

The app will show a line on the screen showing the driven route. The line may only display when the vehicle is moving. The app collects all GPS data, but only visualizes the data that has a minimum speed. The app continuously reports all GPS data to the application backend to store in the database. The trip state will update to processing upon starting the trip.

Further, when the driver has completed the test trip, he/she will end the trip. A confirmation dialog will appear. After confirming, the trip status will change to complete.

For each state change, the application backend will process or post-process the GPS data.

Further, the disclosed system may be configured for reviewing test results. The test administrator will use the web application to monitor the drivers and trip plans. Further, the test administrator can view the driver's location in real-time. Further, the test administrator may view the trip plan and trip statuses in real-time. In addition to seeing a bird's eye view of all the drivers, the test administrator can view the specific driver location and trail for a specific trip. The map will update in real-time and follow the driver as he/she drives.

The client can download the tolling application data. Further, the disclosed system may allow them to download it in command-separated value (CSV) format. It also provides a reporting feature and dashboard that allows the client to visualize the data.

Further, the tolling application allows the client to define a Point of Interest (POI). The POI is a single GPS location. The POI allows the customer to add markers, waypoints, or check-in locations during a test trip. The test trip defines where the driver must make the trip. The POI can be used to confirm whether the driver has driven near a specific location. Examples of POIs are toll gantries, toll booths, entries, exits, and intersections.

POI check-ins allow a client to determine whether the driver drove by a POI and at what time. For example, the client wants to know the time when a driver drove by an automated toll booth. This data becomes an independent record he/she can use to check against their tolling equipment records. The client can claim their tolling equipment is working accurately when the tolling application record matches the tolling equipment record. The client can determine their tolling equipment might need adjustments when the tolling application record and the tolling equipment records fail to match.

Further, the tolling application calculates the POI check-ins by evaluating the trip GPS coordinates with the POI coordinates. The platform gives a margin of error (e.g., 0.01 km) and uses that as a radius from the POI coordinate to draw a circle. The platform uses the trip GPS coordinates to draw a polyline for the trip. It then calculates whether the line intersects the POI circle. It will calculate the time range when the vehicle entered and exited the POI circle if the trip line intersects it. This calculation becomes the POI check-in. The tolling web application will visualize the POI as having a check-in and will also display a tabular format showing the GPS coordinate and the time.

Further, the disclosed system may be configured for passive tracking and continuous trip auditing. Further, the tolling platform may actively track trips. This means that a specific trip plan has a specific trip assigned to a specific driver for a specific time window. The driver must actively acknowledge the start and stop of the trip. During that trip execution, the GPS data is associated with the specific test trip, test plan, and driver.

Passive tracking allows any driver to report their GPS coordinates to the tolling application backend. The platform may retroactively determine whether the driver took a trip that matches the desired test trip. This capability gives the client flexibility in auditing their tolling equipment. The client no longer needs to hire drivers or ask an application to hire drivers, orchestrate a big test event, actively track the trip plan execution, and manage all the drivers during test day. The client simply needs to specify which test trips they want, and the days they want it tested. Now anyone with the tolling mobile app or a mobile app running the tolling application GPS tracking code is eligible to be a tester. Any driver that already drives the toll roads (or whatever roads are under test) may become a tester for any tolling application client. The driver might even be eligible to earn compensation when their drive successfully verifies a test trip. Essentially, this capability enables crowdsourcing of test trips for the tolling platform. With a sufficient number of drivers running passive tracking, the platform can start performing continuous testing. Continuous testing is the capability of testing a trip more than once per day and multiple days per week. Further, the disclosed system may aggregate the test data and start building visual dashboards, data reports, and even alerting capability. For example, let's suppose there is a toll booth that is having intermittent issues. Further, there may be several drivers passing through that toll booth throughout the day. The data collection might show that we had 20 trips with 20 POI check-ins, but the toll road equipment only captured 10 of those trips. Further, dashboards and reports associated with the disclosed system may show 10/20 trip accuracy and a degraded state. Further, an alert may be sent whenever trip accuracy falls before a given percentage (e.g., 80%) which would allow the client to respond proactively rather than waiting to review the dashboard and report.

There are two methodologies to calculate passive trips.

Further, a first methodology of the two methodologies is to match the actual GPS data against the desired trip route. Further, the disclosed system may calculate the distance between the actual GPS coordinates and the trip route waypoints. If the sum of the total distances is less than a specified number, we would count the actual trip as matching the desired trip. For simplicity, we can convert the actual and desired trip route into an area and calculate the overlap area. If there is a minimum area overlap, we would count the actual trip as matching the desired trip.

Further, a second methodology of the two methodologies may determine whether the actual trip matches the desired trip is by leveraging POIs and POI check-ins. The client may define a series of POIs that make up a trip. Further, if the client wants to crowdsource driving from home to work via the toll road. The client determines there are three (3) POIs a driver must pass by within 30 minutes to be a valid trip. The client would create a passive trip plan, specify the three POIs, their desired order, whether all or some (e.g., 2 out of 3) need to check-ins and the desired time window. The platform may review the POI check-in data and compare that against the criteria. The trip may count as a passive trip when all the required criteria are met. In our supposed example, all three POIs must check-in in the correct order and within 30 minutes for the actual trip to match the desired trip.

The client may choose to use one or both of the methods when enabling passive trip tracking and continuous trip auditing.

Further, the platform will have a data store of GPS coordinates from active trips and passive trips. Over time, all these GPS coordinates would provide a representation of the physical road. If visualized, a cloud of dots resembling the physical toll road lanes may be seen. The platform may use this historical data to automatically draw trip routes for our clients. This approach comes in handy when third-party solutions do not have any data or the data is incomplete/inaccurate to successfully draw a trip route.

Furthermore, the platform may be used to audit pricing signs. Pricing signs display the price a toll road customer is expected to pay upon driving the toll road. For example, the sign is located near the toll road entrance and may say $5.00 to a specific city. If the sign showed $5.00, but the customer was billed $6.00, then the toll road is required to refund $1.00. If the sign showed the incorrect price, even if the customer was billed the correct trip price, the toll road operator must refund any overages because the sign showed a lower trip. If the sign had an outage, the toll road operator must refund all trips. The inaccuracy and outages of pricing signs may have detrimental business implications and without proper auditing and alerting, the business has a significant monetary risk.

Further, the tolling application helps audit the pricing signs. There are multiple ways the platform supports pricing sign auditing:
The driver uses the mobile app to enter the pricing sign price he/she saw before entering the toll road.
The driver uses the mobile app to upload a picture of the pricing sign and enters the price value.
An external system takes periodic photos of the pricing sign. The mobile app shows the photo to the driver and asks the driver to confirm whether the price was correct and/or to entire the price value.
An external system takes periodic photos of the pricing sign. Artificial intelligence (AI) or machine learning (ML) uses the photo to automatically detect the price value.
The platform can compare the driver-provided price value and the automatically-detected price value of the photo and determine a confidence score and use the human data to improve the AI/ML algorithm.
Any of the above approaches allow reporting that there was no price or that the pricing sign was turned off.

The platform may use one or all these approaches at any given time. All approaches may provide a record of the pricing sign value for a given time. The client would use this external record to compare against their internal pricing records. The pricing sign is deemed to be working if the records match. If the pricing sign might be deemed as degraded if the records fail to match. The pricing sign may be deemed as non-operational if there was no price or the pricing sign was turned off. The tolling application data records allow the client to audit their pricing signs.

This capability enables monitoring the pricing sign. The platform can send an alert to the toll road operator when it detects there is a gap in pricing history or when the accuracy falls below a certain threshold.

Further, the disclosed system may be configured for Bluetooth™ vehicle identification. Depending on the test trip requirements, the client might need to be able to correlate test trip data with a specific driver. The platform allows assigning personal information, driver license information, transponder information, and vehicle information to a driver assigned to a trip. This way each executed trip will also record the previously mentioned details.

Further, the disclosed system may leverage Bluetooth™ technology to provide an additional verification mechanism to confirm the driver's vehicle. Upon registering for a test event, the driver will enable Bluetooth™ on his/her smartphone. The tolling app will attempt to read the vehicle's Bluetooth signal. Upon successful read, the tolling app will record the details about the vehicle and link it to a vehicle profile. Whenever a driver starts a trip, the tolling application will use the vehicle's Bluetooth™ signal to confirm the identity of the vehicle.

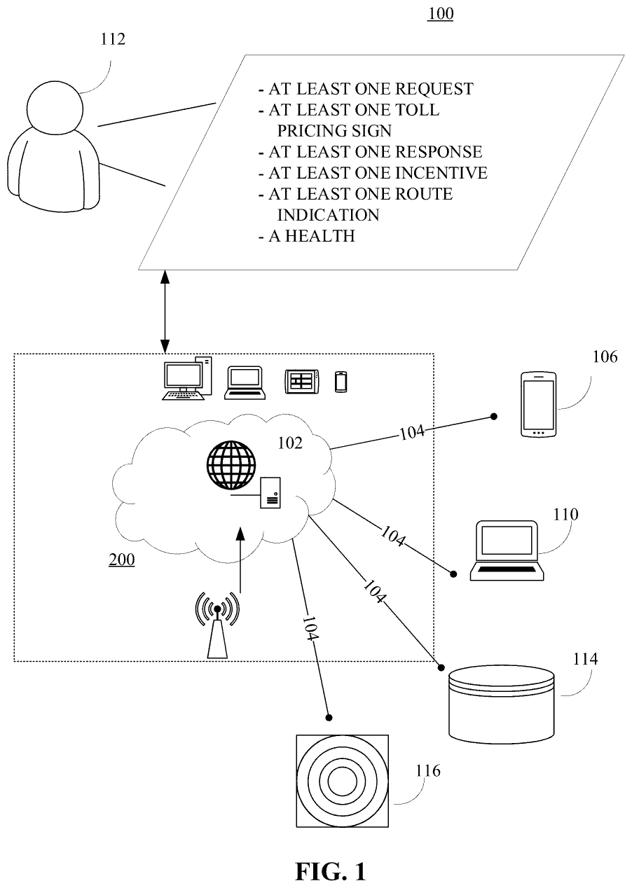

FIG. 1 is an illustration of an online platform 100 consistent with various embodiments of the present disclosure. By way of non-limiting example, the online platform 100 to enable facilitating auditing tolling associated with routes may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

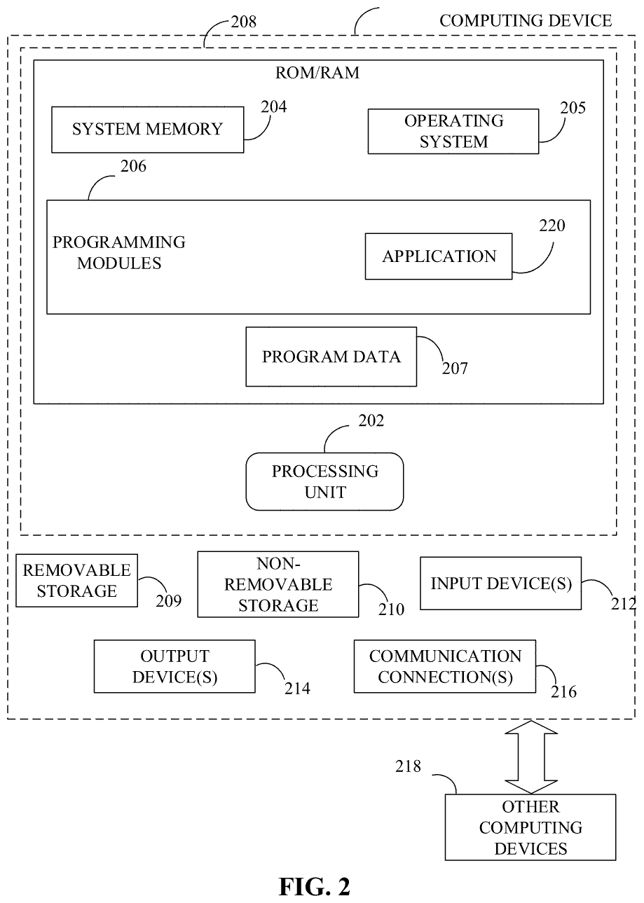

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

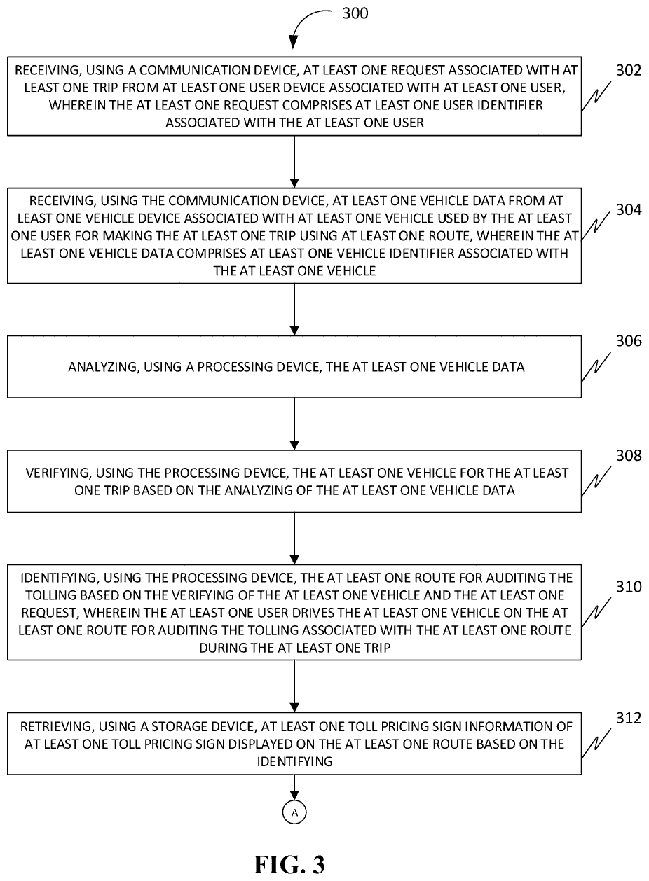

FIG. 3 is a flow chart of a method 300 for facilitating auditing tolling associated with routes, in accordance with some embodiments.

Further, the method 300 may include a step 302 of receiving, using a communication device (such as a communication device 1102), one or more request associated with one or more trip from one or more user device associated with one or more user. Further, the one or more request may include one or more user identifier associated with the one or more user.

Further, the method 300 may include a step 304 of receiving, using the communication device, one or more vehicle data from one or more vehicle device associated with one or more vehicle used by the one or more user for making the one or more trip using one or more route. Further, the one or more vehicle data may include one or more vehicle identifier associated with the one or more vehicle.

Further, the method 300 may include a step 306 of analyzing, using a processing device (such as a processing device 1104), the one or more vehicle data.

Further, the method 300 may include a step 308 of verifying, using the processing device, the one or more vehicle for the one or more trip based on the analyzing of the one or more vehicle data.

Further, the method 300 may include a step 310 of identifying, using the processing device, the one or more route for auditing the tolling based on the verifying of the one or more vehicle and the one or more request. Further, the one or more user drives the one or more vehicle on the one or more route for auditing the tolling associated with the one or more route during the one or more trip.

Further, the method 300 may include a step 312 of retrieving, using a storage device (such as a storage device 1106), one or more toll pricing sign information of one or more toll pricing sign displayed on the one or more route based on the identifying.

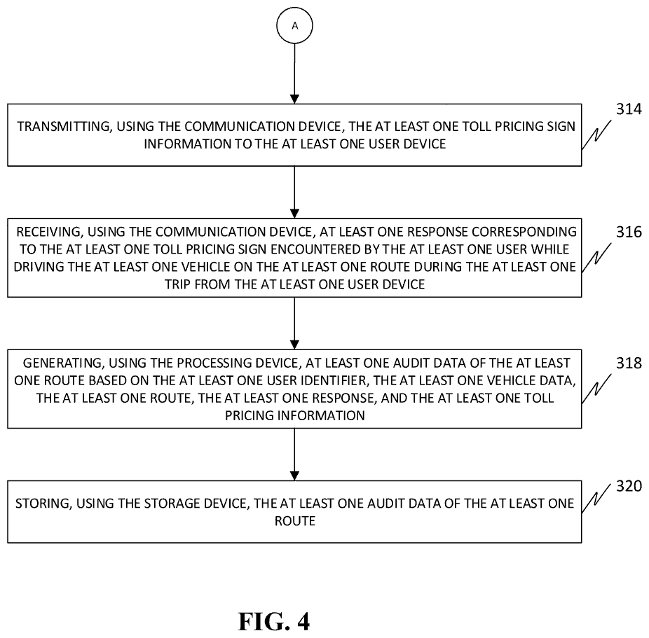

FIG. 4 is a continuation flow chart of FIG. 3.

Further, the method 300 may include a step 314 of transmitting, using the communication device, the one or more toll pricing sign information to the one or more user device.

Further, the method 300 may include a step 316 of receiving, using the communication device, one or more response corresponding to the one or more toll pricing sign encountered by the one or more user while driving the one or more vehicle on the one or more route during the one or more trip from the one or more user device.

Further, the method 300 may include a step 318 of generating, using the processing device, one or more audit data of the one or more route based on the one or more user identifier, the one or more vehicle data, the one or more route, the one or more response, and the one or more toll pricing information.

Further, the method 300 may include a step 320 of storing, using the storage device, the one or more audit data of the one or more route.

In some embodiments, the one or more vehicle device may include one or more location sensor. Further, the one or more location sensor may be configured for generating one or more location data based on detecting a location of the one or more vehicle and a time corresponding to the location during the one or more trip. Further, the one or more vehicle data may include the one or more location data.

Further, in some embodiments, the at least one vehicle data may include at least one of a license plate information associated with the at least one vehicle, a vehicle identification information associated with the at least one vehicle, a vehicle model information associated with the at least one vehicle, a vehicle make information associated with the at least one vehicle, and a vehicle device identification information associated with the at least one vehicle device. Further, the license plate information may include a license plate number (LPN) of the at least one vehicle. Further, the vehicle identification information may include a vehicle identification number (VIN) of the at least one vehicle. Further, the vehicle model information may include a vehicle type of the at least one vehicle. Further, the vehicle make information may include a number and a type of axels of the at least one vehicle. Further, the vehicle device information may include a transponder identification number of a transponder. Further, the at least one vehicle device may include the transponder.

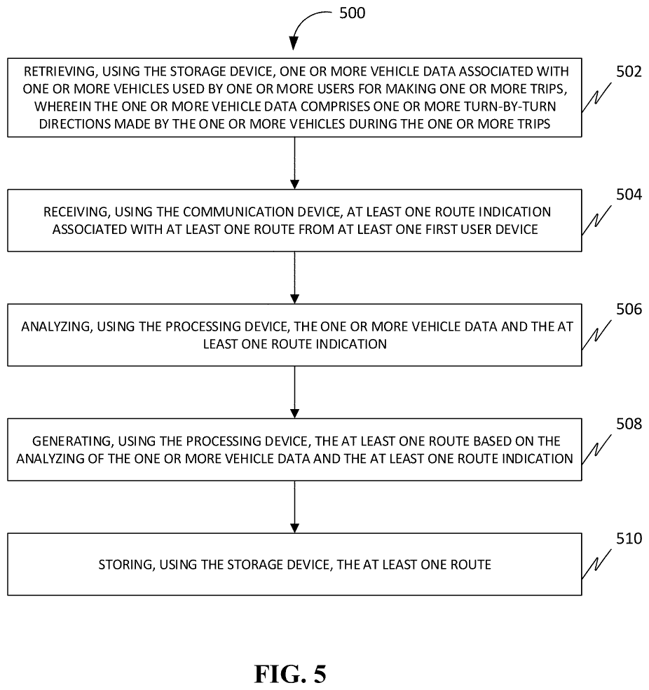

FIG. 5 is a flow chart of a method 500 for facilitating auditing tolling associated with routes in which the method 500 may include storing, using the storage device, the one or more route, in accordance with some embodiments. Further, at 502, the method 500 may include retrieving, using the storage device, one or more vehicle data associated with one or more vehicles used by one or more users for making one or more trips. Further, the one or more vehicle data may include one or more turn-by-turn directions made by the one or more vehicles during the one or more trips. Further, at 504, the method 500 may include receiving, using the communication device, one or more route indication associated with one or more route from one or more first user device. Further, at 506, the method 500 may include analyzing, using the processing device, the one or more vehicle data and the one or more route indication. Further, at 508, the method 500 may include generating, using the processing device, the one or more route based on the analyzing of the one or more vehicle data and the one or more route indication. Further, at 510, the method 500 may include storing, using the storage device, the one or more route.

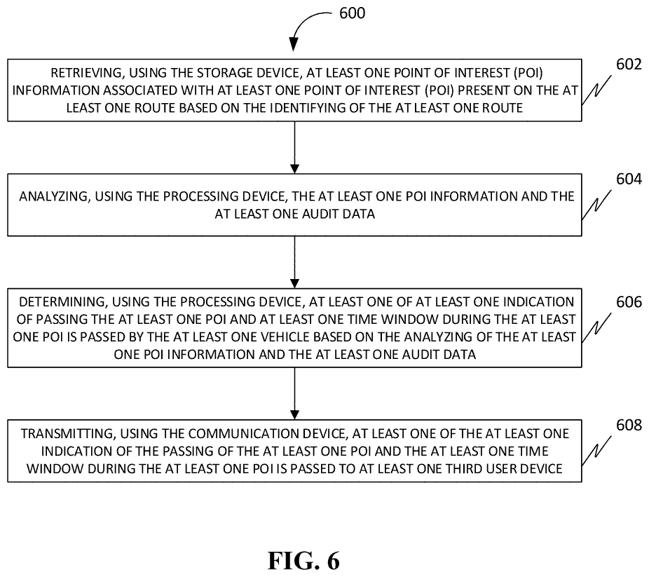

FIG. 6 is a flow chart of a method 600 for facilitating auditing tolling associated with routes in which the method 600 may include transmitting one or more of the one or more indication of the passing of the one or more point of interest (POI) and the one or more time window to one or more third user device, in accordance with some embodiments. Further, at 602, the method 600 may include a step of retrieving, using the storage device, one or more point of interest (POI) information associated with one or more point of interest (POI) present on the one or more route based on the identifying of the one or more route. Further, at 604, the method 600 may include a step of analyzing, using the processing device, the one or more POI information and the one or more audit data. Further, at 606, the method 600 may include a step of determining, using the processing device, one or more of one or more indication of passing the one or more POI and one or more time window during the one or more POI may be passed by the one or more vehicle based on the analyzing of the one or more POI information and the one or more audit data. Further, at 608, the method 600 may include a step of transmitting, using the communication device, one or more of the one or more indication of the passing of the one or more POI and the one or more time window during the one or more POI may be passed to one or more third user device.

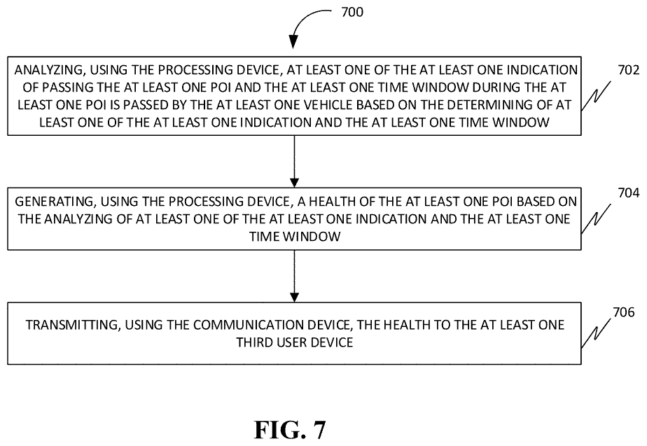

FIG. 7 is a flow chart of a method 700 for facilitating auditing tolling associated with routes in which the method 700 may include transmitting a health to the one or more third user device, in accordance with some embodiments. Further, at 702, the method 700 may include a step of analyzing, using the processing device, one or more of the one or more indication of passing the one or more POI and the one or more time window during the one or more POI may be passed by the one or more vehicle based on the determining of one or more of the one or more indication and the one or more time window. Further, at 704, the method 700 may include a step of generating, using the processing device, a health of the one or more POI based on the analyzing of one or more of the one or more indication and the one or more time window. Further, at 706, the method 700 may include a step of transmitting, using the communication device, the health to the one or more third user device.

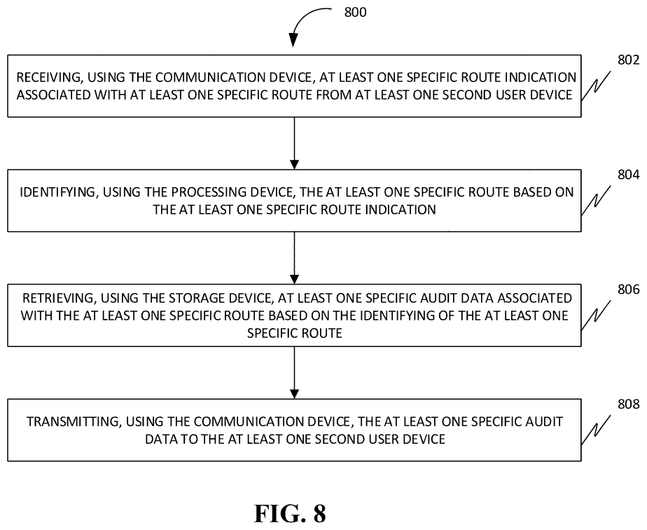

FIG. 8 is a flow chart of a method 800 for facilitating auditing tolling associated with routes in which the method 800 may include transmitting the one or more specific audit data to the one or more second user device, in accordance with some embodiments. Further, at 802, the method 800 may include a step of receiving, using the communication device, one or more specific route indication associated with one or more specific route from one or more second user device. Further, at 804, the method 800 may include a step of identifying, using the processing device, the one or more specific route based on the one or more specific route indication. Further, at 806, the method 800 may include a step of retrieving, using the storage device, one or more specific audit data associated with the one or more specific route based on the identifying of the one or more specific route. Further, at 808, the method 800 may include a step of transmitting, using the communication device, the one or more specific audit data to the one or more second user device.

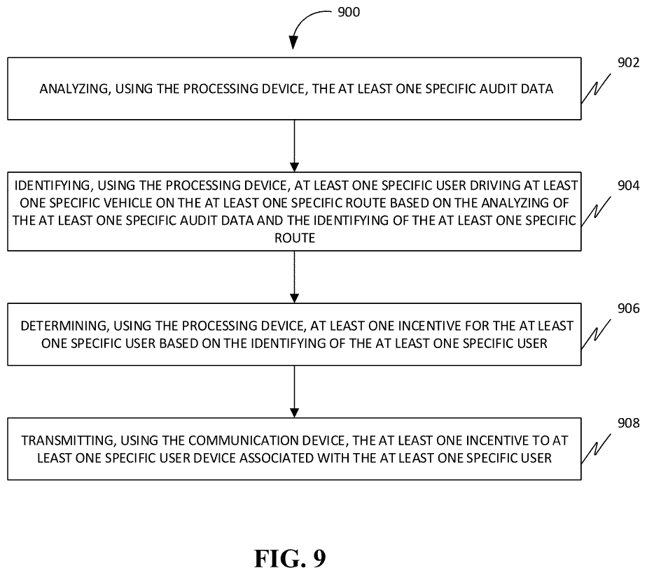

FIG. 9 is a flow chart of a method 900 for facilitating auditing tolling associated with routes in which the method 900 may include transmitting the one or more incentive to one or more specific user device associated with the one or more specific user, in accordance with some embodiments. Further, at 902, the method 900 may include a step of analyzing, using the processing device, the one or more specific audit data. Further, at 904, the method 900 may include a step of identifying, using the processing device, one or more specific user driving one or more specific vehicle on the one or more specific route based on the analyzing of the one or more specific audit data and the identifying of the one or more specific route. Further, at 906, the method 900 may include a step of determining, using the processing device, one or more incentive for the one or more specific user based on the identifying of the one or more specific user. Further, at 908, the method 900 may include a step of transmitting, using the communication device, the one or more incentive to one or more specific user device associated with the one or more specific user.

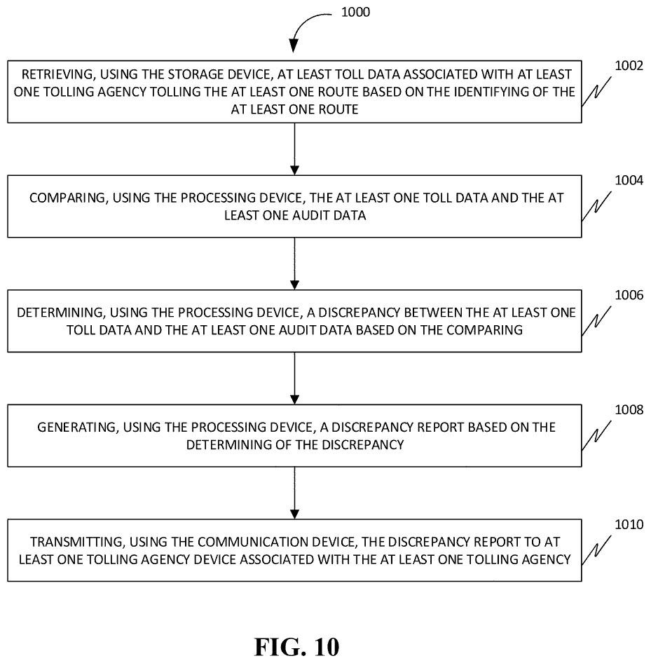

FIG. 10 is a flow chart of a method 1000 for facilitating auditing tolling associated with routes in which the method 1000 may include transmitting the discrepancy report to one or more tolling agency device associated with the one or more tolling agency, in accordance with some embodiments. Further, at 1002, the method 1000 may include a step of retrieving, using the storage device, at least toll data associated with one or more tolling agency tolling the one or more route based on the identifying of the one or more route. Further, at 1004, the method 1000 may include a step of comparing, using the processing device, the one or more toll data and the one or more audit data. Further, at 1006, the method 1000 may include a step of determining, using the processing device, a discrepancy between the one or more toll data and the one or more audit data based on the comparing. Further, at 1008, the method 1000 may include a step of generating, using the processing device, a discrepancy report based on the determining of the discrepancy. Further, at 1010, the method 1000 may include a step of transmitting, using the communication device, the discrepancy report to one or more tolling agency device associated with the one or more tolling agency.

In some embodiments, the one or more user device may include one or more image sensor. Further, the one or more image sensor may be configured for generating one or more toll pricing sign image of the one or more toll pricing sign based on capturing the one or more toll pricing sign. Further, the one or more response may include the one or more toll pricing sign image.

In some embodiments, the one or more user device may include one or more input device. Further, the one or more input device may be configured for generating the one or more response based on one or more action performed on the one or more input device by the one or more user.

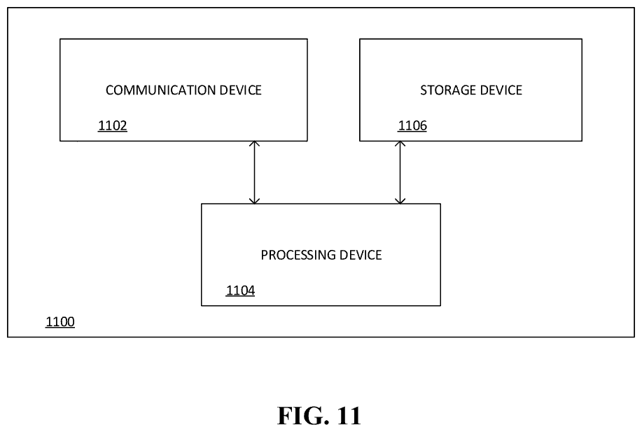

FIG. 11 is a block diagram of a system 1100 for facilitating auditing tolling associated with routes, in accordance with some embodiments. The system 1100 may include a communication device 1102, a processing device 1104, and a storage device 1106.

Further, the communication device 1102 may be configured for performing a step of receiving one or more request associated with one or more trip from one or more user device associated with one or more user. Further, the one or more request may include one or more user identifier associated with the one or more user.

Further, the communication device 1102 may be configured for performing a step of receiving one or more vehicle data from one or more vehicle device associated with one or more vehicle used by the one or more user for making the one or more trip using one or more route. Further, the one or more vehicle data may include one or more vehicle identifier associated with the one or more vehicle.

Further, the communication device 1102 may be configured for performing a step of transmitting one or more toll pricing sign information to the one or more user device.

Further, the communication device 1102 may be configured for performing a step of receiving one or more response corresponding to one or more toll pricing sign encountered by the one or more user while driving the one or more vehicle on the one or more route during the one or more trip from the one or more user device.

The processing device 1104 may be communicatively coupled with the communication device 1102.

Further, the processing device 1104 may be configured for performing a step of analyzing the one or more vehicle data.

Further, the processing device 1104 may be configured for performing a step of verifying the one or more vehicle for the one or more trip based on the analyzing of the one or more vehicle data.

Further, the processing device 1104 may be configured for performing a step of identifying the one or more route for auditing the tolling based on the verifying of the one or more vehicle and the one or more request. Further, the one or more user drives the one or more vehicle on the one or more route for auditing the tolling associated with the one or more route during the one or more trip.

Further, the processing device 1104 may be configured for performing a step of generating one or more audit data of the one or more route based on the one or more user identifier, the one or more vehicle data, the one or more route, the one or more response, and the one or more toll pricing information.

The storage device 1106 may be communicatively coupled with the processing device 1104.

Further, the storage device 1106 may be configured for performing a step of retrieving the one or more toll pricing sign information of the one or more toll pricing sign displayed on the one or more route based on the identifying.

Further, the storage device 1106 may be configured for performing a step of storing the one or more audit data of the one or more route.

In some embodiments, the one or more vehicle device may include one or more location sensor. Further, the one or more location sensor may be configured for generating one or more location data based on detecting a location of the one or more vehicle and a time corresponding to the location during the one or more trip. Further, the one or more vehicle data may include the one or more location data.

In some embodiments, the storage device 1106 may be configured for performing a step of retrieving one or more vehicle data associated with one or more vehicles used by one or more users for making one or more trips. Further, the one or more vehicle data may include one or more turn-by-turn directions made by the one or more vehicles during the one or more trips. Further, the storage device 1106 may be configured for performing a step of storing the one or more route. Further, the communication device 1102 may be configured for performing a step of receiving one or more route indication associated with one or more route from one or more first user device. Further, the processing device 1104 may be configured for performing a step of analyzing the one or more vehicle data and the one or more route indication. Further, the processing device 1104 may be configured for performing a step of generating the one or more route based on the analyzing of the one or more vehicle data and the one or more route indication.

In some embodiments, the storage device 1106 may be configured for performing a step of retrieving one or more point of interest (POI) information associated with one or more point of interest (POI) present on the one or more route based on the identifying of the one or more route. Further, the processing device 1104 may be configured for performing a step of analyzing the one or more POI information and the one or more audit data. Further, the processing device 1104 may be configured for performing a step of determining one or more of one or more indication of passing the one or more POI and one or more time window during the one or more POI may be passed by the one or more vehicle based on the analyzing of the one or more POI information and the one or more audit data. Further, the communication device 1102 may be configured for performing a step of transmitting one or more of the one or more indication of the passing of the one or more POI and the one or more time window during the one or more POI may be passed to one or more third user device.

In some embodiments, the processing device 1104 may be configured for performing a step of analyzing one or more of the one or more indication of passing the one or more POI and the one or more time window during the one or more POI may be passed by the one or more vehicle based on the determining of one or more of the one or more indication and the one or more time window. Further, the processing device 1104 may be configured for performing a step of generating a health of the one or more POI based on the analyzing of one or more of the one or more indication and the one or more time window. Further, the communication device 1102 may be configured for performing a step of transmitting the health to the one or more third user device.

In some embodiments, the communication device 1102 may be configured for performing a step of receiving one or more specific route indication associated with one or more specific route from one or more second user device. Further, the communication device 1102 may be configured for performing a step of transmitting one or more specific audit data to the one or more second user device. Further, the processing device 1104 may be configured for performing a step of identifying the one or more specific route based on the one or more specific route indication. Further, the storage device 1106 may be configured for performing a step of retrieving the one or more specific audit data associated with the one or more specific route based on the identifying of the one or more specific route.

In some embodiments, the processing device 1104 may be configured for performing a step of analyzing the one or more specific audit data. Further, the processing device 1104 may be configured for performing a step of identifying one or more specific user driving one or more specific vehicle on the one or more specific route based on the analyzing of the one or more specific audit data and the identifying of the one or more specific route. Further, the processing device 1104 may be configured for performing a step of determining one or more incentive for the one or more specific user based on the identifying of the one or more specific user. Further, the communication device 1102 may be configured for performing a step of transmitting the one or more incentive to one or more specific user device associated with the one or more specific user.

In some embodiments, the storage device 1106 may be configured for performing a step of retrieving at least toll data associated with one or more tolling agency tolling the one or more route based on the identifying of the one or more route. Further, the processing device 1104 may be configured for performing a step of comparing the one or more toll data and the one or more audit data. Further, the processing device 1104 may be configured for performing a step of determining a discrepancy between the one or more toll data and the one or more audit data based on the comparing. Further, the processing device 1104 may be configured for performing a step of generating a discrepancy report based on the determining of the discrepancy. Further, the communication device 1102 may be configured for performing a step of transmitting the discrepancy report to one or more tolling agency device associated with the one or more tolling agency.

In some embodiments, the one or more user device may include one or more image sensor. Further, the one or more image sensor may be configured for generating one or more toll pricing sign image of the one or more toll pricing sign based on capturing the one or more toll pricing sign. Further, the one or more response may include the one or more toll pricing sign image.

In some embodiments, the one or more user device may include one or more input device. Further, the one or more input device may be configured for generating the one or more response based on one or more action performed on the one or more input device by the one or more user.

Further, in some embodiments, the at least one vehicle data may include at least one of a license plate information associated with the at least one vehicle, a vehicle identification information associated with the at least one vehicle, a vehicle model information associated with the at least one vehicle, a vehicle make information associated with the at least one vehicle, and a vehicle device identification information associated with the at least one vehicle device. Further, the license plate information may include a license plate number of the at least one vehicle. Further, the vehicle identification information may include a vehicle identification number of the at least one vehicle. Further, the vehicle model information may include a vehicle type of the at least one vehicle. Further, the vehicle make information may include a number and a type of axels of the at least one vehicle. Further, the vehicle device information may include a transponder identification number of a transponder. Further, the at least one vehicle device may include the transponder.

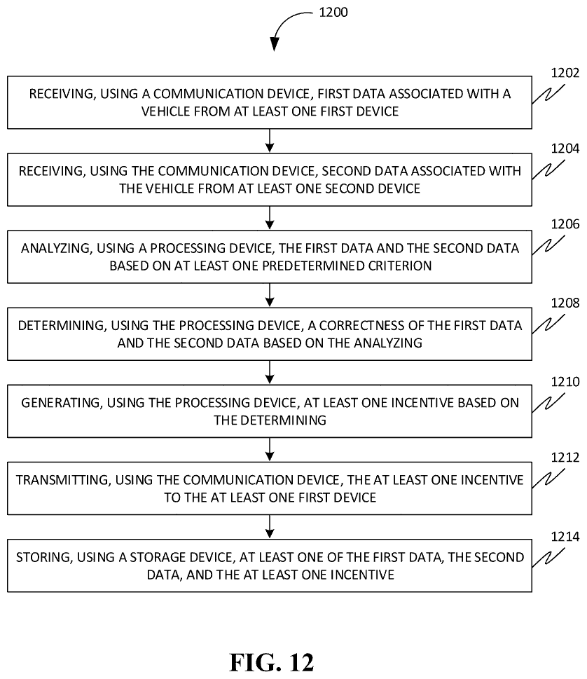

FIG. 12 is a flowchart of a method 1200 for facilitating managing of toll systems, in accordance with some embodiments. Further, at 1202, the method 1200 may include a step of receiving, using a communication device, first data associated with a vehicle from at least one first device. Further, the first data may include location information of the vehicle. Further, the at least one first device may be associated with at least one user. Further, the at least one user may be associated with the vehicle. Further, the at least one first device may be configured for generating the first sensor data. Further, in an embodiment, the at least one first device may include at least one sensor. Further, the at least one sensor may be configured for generating at least one information associated with the toll system. Further, the first data may include the at least one information.

Further, at 1204, the method 1200 may include a step of receiving, using the communication device, second data associated with the vehicle from at least one second device. Further, the at least one second device may be associated with the toll systems. Further, the at least one second device may be communicatively couplable with the at least one first device. Further, the at least one second device may be configurable for establishing a connection with the at least one first device. Further, the at least one second device may be configured for generating the second data based on the establishing.

Further, at 1206, the method 1200 may include a step of analyzing, using a processing device, the first data and the second data based on at least one predetermined criterion. Further, the at least one predetermined criterion may include at least one predetermined trip route. Further, the at least one predetermined trip route may include at least one point of interest.

Further, at 1208, the method 1200 may include a step of determining, using the processing device, a correctness of the first data and the second data based on the analyzing.

Further, at 1210, the method 1200 may include a step of generating, using the processing device, at least one incentive based on the determining.

Further, at 1212, the method 1200 may include a step of transmitting, using the communication device, the at least one incentive to the at least one first device.

Further, at 1214, the method 1200 may include a step of storing, using a storage device, at least one of the first data, the second data, and the at least one incentive.

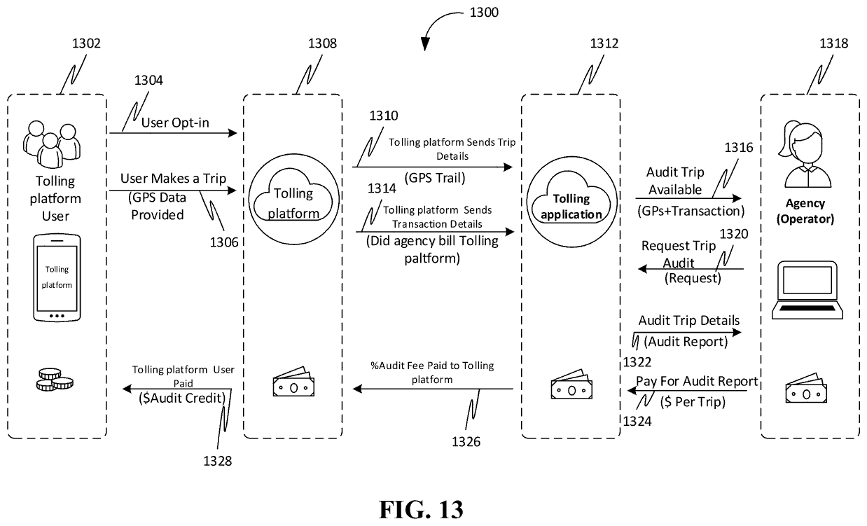

FIG. 13 is a flow diagram of a method 1300 for facilitating managing of toll systems using a Tolling Platform 1308, in accordance with some embodiments. Further, at 1304, the method 1300 may include a tolling platform user 1302 associated with the Tolling Platform 1308 opting in using the Tolling Platform 1308. Further, at 1306, the method 1300 may include the tolling platform user 1302 making a trip. Further, GPS data may be provided to the tolling platform 1308 based on the making of the trip. Further, 1310, the method 1300 may include the tolling platform 1308 sending trip details comprising GPS trail associated with the trip to a tolling application 1312. Further, at 1314, the method 1300 may include the Tolling Platform 1308 sending transaction details to the tolling application 1312. Further, at 1316, the method 1300 may include the tolling application 1312 sending an availability of an audit trip comprising GPS and transaction to an agency operator 1318. Further, at 1320, the method 1300 may include the agency operator 1318 requesting the trip audit with the tolling application 1312. Further, at 1322, the method 1300 may include the tolling application 1312 sending an audit trip details comprising an audit report to the agency operator 1318. Further, at 1324, the method 1300 may include the agency operator paying the tolling application 1312 for the audit report per trip. Further, at 1326, the method 1300 may include the tolling application 1312 paying % audit fees to the tolling platform 1308. Further, at 1328, the method 1300 may include the tolling platform user 1302 getting paid by the tolling platform 1308.

Further, the tolling platform 1308 may be associated with a Software Development Kit (SDK) that sends the GPS data to the tolling application 1312. Further, a user associated with the tolling platform 1308 may opt-in using the tolling platform 1308. Further, the user may make a trip for providing GPS data to the tolling platform 1308. Further, the tolling platform 1308 pays the tolling platform user with an audit credit. Further, the tolling platform 1308 sends trip details comprising GPS trail to the tolling application 1312. Further, the tolling platform 1308 sends transaction details to the tolling application 1312. Further, the tolling application 1312 pays the audit fee to the tolling platform 1308. Further, the tolling application 1312 sends an availability of an audit trip comprising GPS and transaction to an agency operator. Further, the agency operator may request the trip audit with the tolling application 1312. Further, the tolling application 1312 may send audit trip details comprising an audit report to the agency operator. Further, the agency operator pays the tolling application 1312 for the audit report per trip.

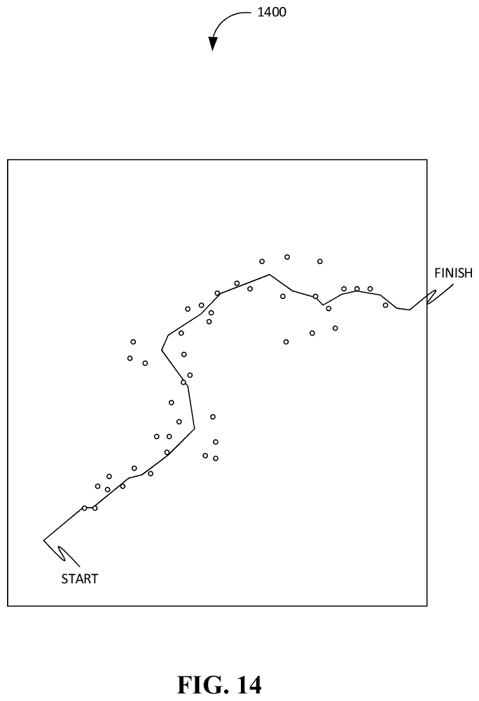

FIG. 14 is an illustration 1400 describing a calculation method of a route for facilitating active, passive, and continuous GPS trip tracking and vehicle identification, in accordance with some embodiments.

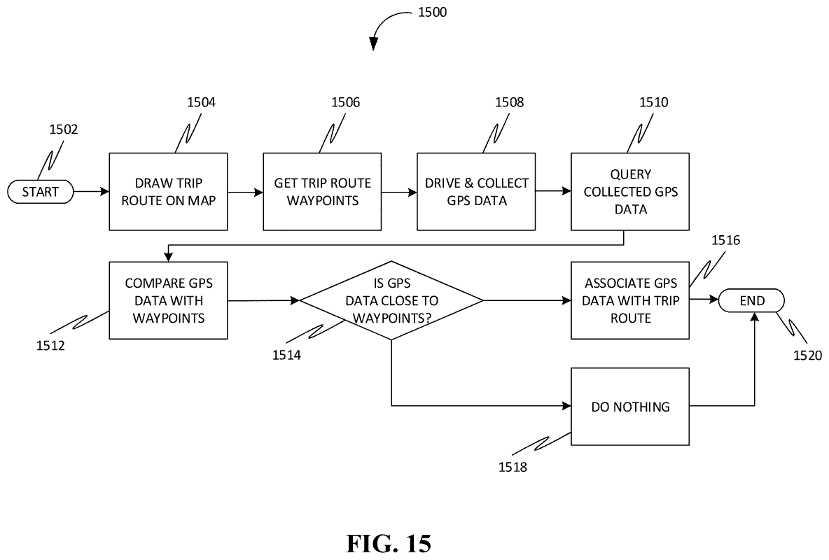

FIG. 15 is a flow diagram of a method 1500 for facilitating active, passive, and continuous GPS trip tracking and vehicle identification, in accordance with some embodiments. Further, at 1502, the method 1500 may include a starting step. Further, at 1504, the method 1500 may include a step of drawing a trip route on a map. Further, at 1506, the method 1500 may include a step of getting trip route waypoints. Further, at 1508, the method 1500 may include a step of driving and collecting GPS data. Further, at 1510, the method 1500 may include a step of querying collected GPS data. Further, at 1512, the method 1500 may include a step of comparing the GPS data with the waypoints. Further, at 1514, the method 1500 may include a step of determining whether the GPS data is close to the waypoints. Further, at 1516, the method 1500 may include a step of associating the GPS data with the trip route if the GPS data is close to the waypoints. Further, at 1518, the method 1500 may include doing nothing if the GPS data is not close to the waypoints. Further, at 1520, the method 1500 may include an ending step.

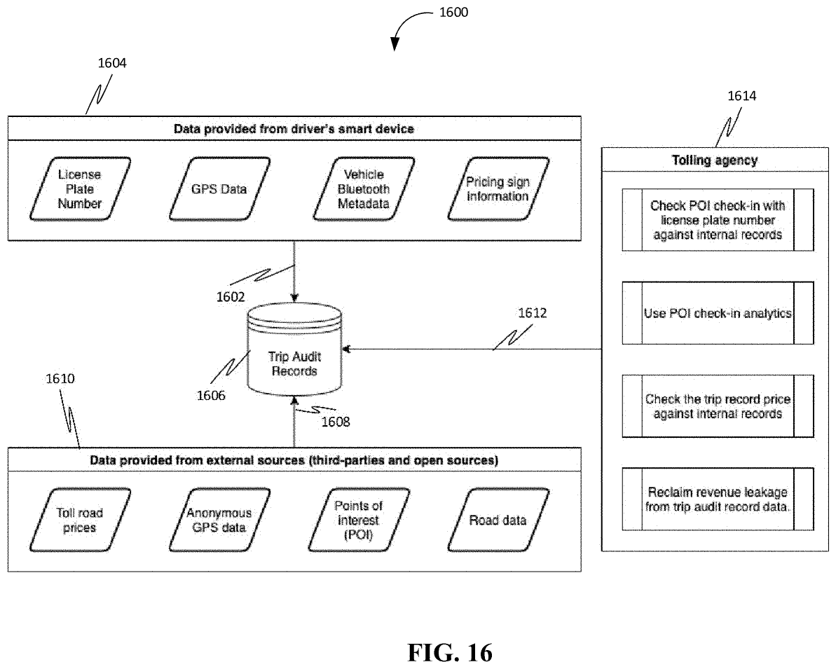

FIG. 16 is a flow diagram of a method 1600 for facilitating managing of toll systems, in accordance with some embodiments. Accordingly, at 1602, the method 1600 may include storing data 1604 provided from driver's smartphone into trip audit records 1606. Further, at 1608, the method 1600 may include storing data 1610 provided from external sources into the trip audit records 1606.

Further, crowdsourced GPS data (or GPS data) associated with the disclosed system may include vehicle's license plate number, additional metadata (e.g., vehicle Bluetooth™ data), and a trip price that goes into the audit trip record 1606. The GPS data may not be mass aggregated and kept anonymous, unlike some conventional systems. Furthermore, the driver may help confirm the trip price that adds validity to the audit trip record 1606. Further, at 1612, the method 1600 may include a tolling agency 1614 using the audit trip record's check-in timestamp, the license plate number, and the trip price to verify the data in their systems. Any discrepancies and omissions can be reconciled. Any omissions in the system associated with the tolling agency 1614 may help them reclaim revenue leakage since the audit trip record contains the license plate, timestamps, and trip price data.

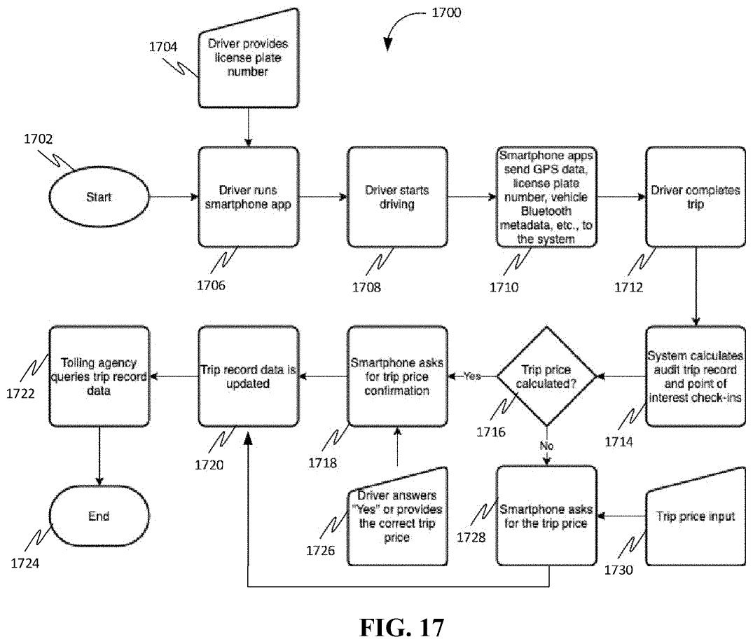

FIG. 17 is a flow diagram of a method 1700 for facilitating managing of toll systems, in accordance with some embodiments. Accordingly, at 1702, the method 1700 may include a starting step. Further, at 1704, the method 1700 may include a driver running a smartphone app. Further, at 1706, the method 1700 may include the driver providing license plate number. Further, at 1708, the method 1700 may include the driver starting driving. Further, at 1710, the method 1700 may include smartphone apps associated with the smartphone sending GPS data, license plate number, vehicle Bluetooth metadata, etc. to the disclosed system. Further, at 1712, the method 1700 may include the driver completing a trip. Further, at 1714, the method 1700 may include the disclosed system calculating audit trip record and point of interest check-ins. Further, at 1716, the method 1700 may include checking if the trip price is calculated. Further, if the trip price is calculated, at 1718, the method 1700 may include the smartphone asking for trip price confirmation. Further, at 1726, the method 1700 may include the driver answering “yes” or providing a correct trip price for the trip price confirmation. Further, at 1720, the method 1700 may include updating a trip record data. Further, at 1722, the method 1700 may include a tolling agency querying the trip record data. Further, at 1724, the method 1700 may include an ending step. Further, if the trip price is not calculated, at 1728, the method 1700 may include the smartphone asking for a trip price. Further, at 1730, the method 1700 may include receiving trip price input.

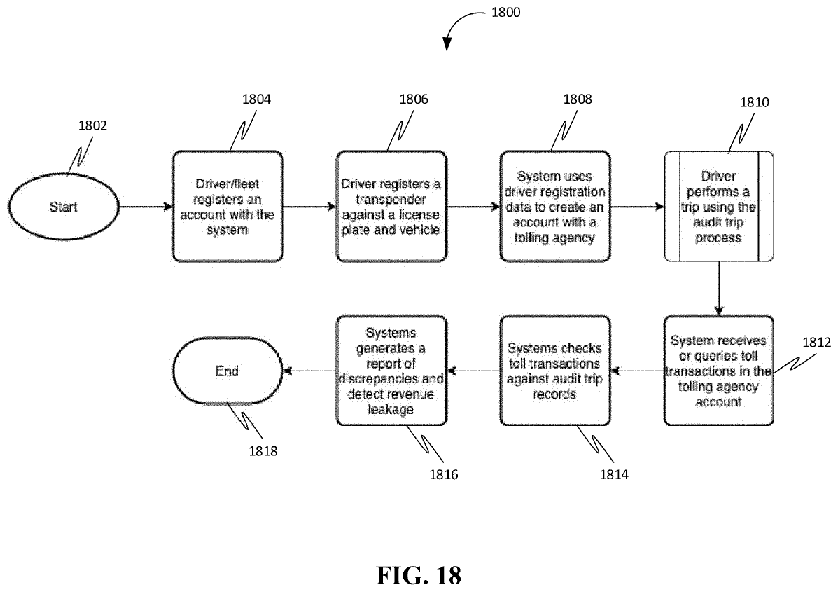

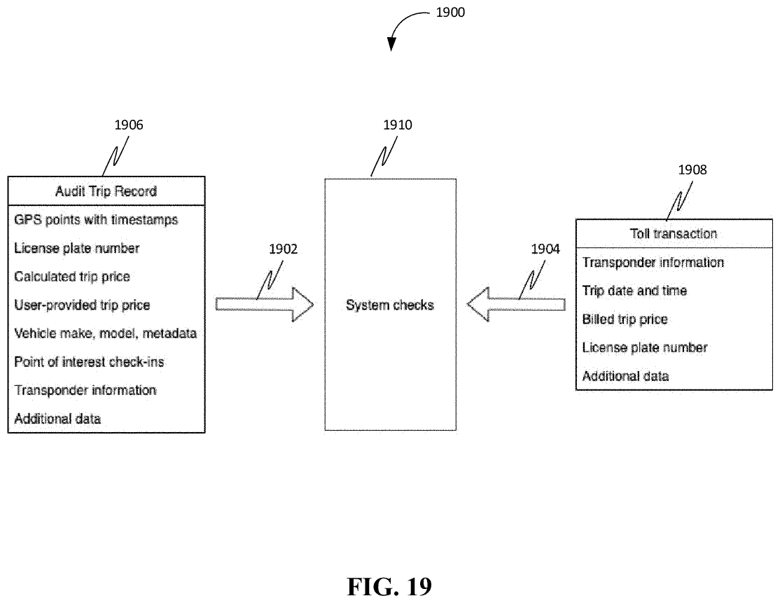

FIG. 18 is a flow diagram of a method 1800 for facilitating managing of toll systems, in accordance with some embodiments. Accordingly, at 1802, the method 1800 may include a starting step. Further, at 1804, the method 1800 may include the driver/driver fleet registering an account with the disclosed system. Further, at 1806, the method 1800 may include the driver registering a transponder against a license plate and vehicle. Further, at 1808, the method 1800 may include the system using driver registration data to create the account with a tolling agency. Further, at 1810, the method 1800 may include the driver performing a trip using an audit trip process. Further, at 1812, the method 1800 may include the disclosed system receiving or querying toll transactions in a tolling agency account. Further, at 1814, the method 1800 may include the disclosed system checking toll transactions against the audit trip record. Further, at 1816, the method 1800 may include the disclosed system generating a report of discrepancies and detecting revenue leakage. Further, at 1818, the method 1800 may include an ending step.

Further, the disclosed system may be configured for facilitating the integration of a transponder and tolling account. Further, a driver or a fleet of drivers may register their transponders have them managed by the system. The driver may associate the transponder in use within the system's smartphone app. The driver may use the app to record their GPS audit trip records. The system may analyze the billing transactions posted to the tolling account for each transponder against the independent GPS audit trip records for the matching transponder. The system may compare the trip cost and timestamps with the GPS audit trip record which has the transponder identifier, a GPS trail with timestamps, and a calculated trip price. The system may send a report to the tolling agency notifying them of detected discrepancies and suspected revenue leakage. Further, the disclosed system may integrate with a driver/driver fleet tolling account associated with a driver/driver fleet to verify the tolling transaction posted properly against the driver/driver fleet tolling account based on the GPS data of the driver/driver fleet. Furthermore, the disclosed system may plug into the tolling agency to verify the source transactions associated with the driver/driver fleet on their end. Further, the disclosed system may potentially detect that a failure of the tolling agency to capture a transaction with the driver/driver fleet accurately or at all. Further, the disclosed system may detect whether the posted transaction is accurately billed to the tolling customer. FIG. 19 is a flow diagram of a method 1900 for facilitating managing of toll systems, in accordance with some embodiments. Accordingly, at 1902, the method 1900 may include receiving audit trip record 1906 that may include GPS points with timestamps, license plate number, calculated trip price, user provided trip price, vehicle make, model, metadata, point of interest check ins, transponder information, and additional data. Further, at 1904, the method 1900 may include receiving toll transaction 1908 that may include transponder information, trip date and time, billed trip price, license plate number, and additional data. Further, at 1910, the method 1900 may include the disclosed system (such as the system 1100) checking the audit trip record 1906 and the toll transaction 1908.

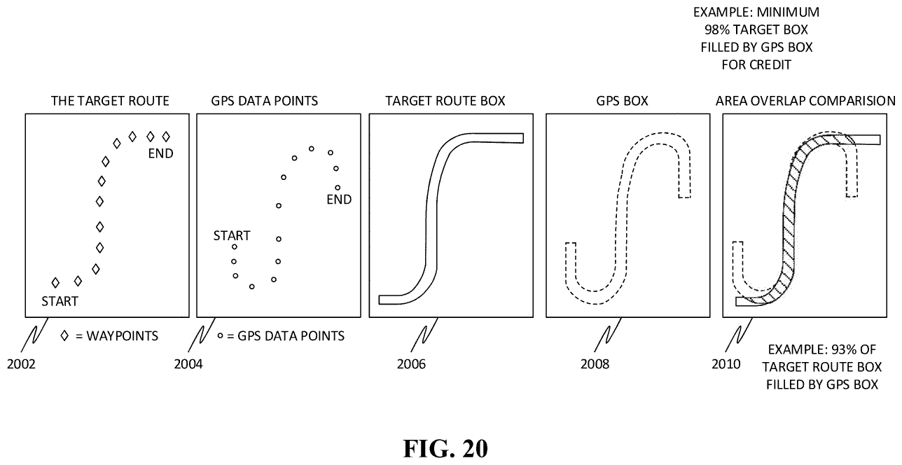

FIG. 20 is illustrations 2002-2010 describing a calculation method of a route for facilitating active, passive, and continuous GPS trip tracking and vehicle identification, in accordance with some embodiments.

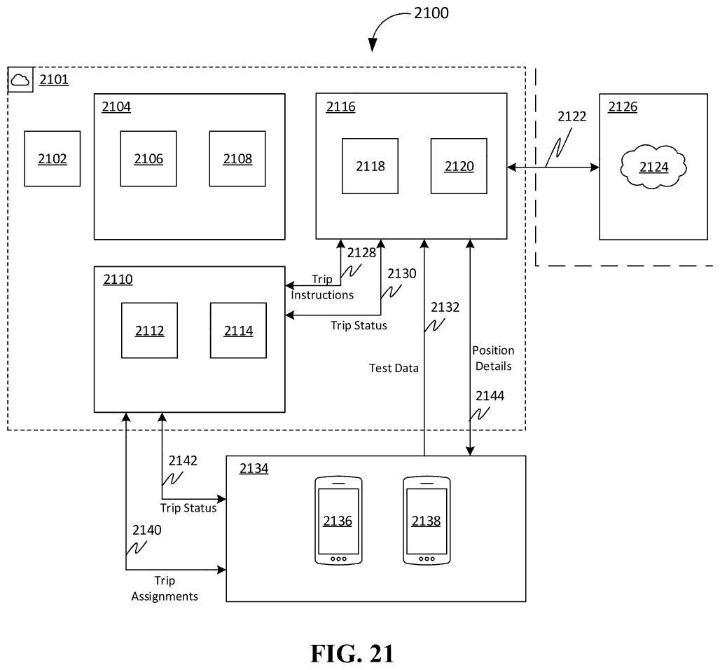

FIG. 21 is a block diagram of a system 2100 for facilitating managing of toll systems, in accordance with some embodiments. Accordingly, the system 2100 may be associated with an tolling application UI and backend 2101. Further, the system 2100 may be associated with a cloud-based storage 2102. Further, the system 2100 may be configured for performing account management 2104 based on microservices 2106 and identity provider 2108. Further, the system 2100 may be configured for performing driver management 2110 based on microservices 2112 and database 2114. Further, the system 2100 may be configured for performing test management 2116 based on microservices 2118 and database 2120. Further, at 2122, the system 2100 may be configured for sharing test analysis with a backoffice system 2124 associated with a client infrastructure 2126. Further, at 2128, the system 2100 may be configured for sharing trip instructions between the driver management 2110 and the test management 2116. Further, at 2130, the system 2100 may be configured for sharing trip status between the driver management 2110 and the test management 2116. Further, at 2132, the system 2100 may be configured for receiving test data for the test management 2116 from test probes 2134. Further, the test probes 2134 may be associated with an Android smartphone 2136 and an iOS device 2138. Further, at 2140, the system 2100 may be configured for sharing trip assignments between the driver management 2110 and the test probes 2134. Further, at 2142, the system 2100 may be configured for sharing trip status between the driver management and the test probes 2134. Further, at 2144, the system 2100 may be configured for sharing positions details between the test management 2116 and the test probes 2134.

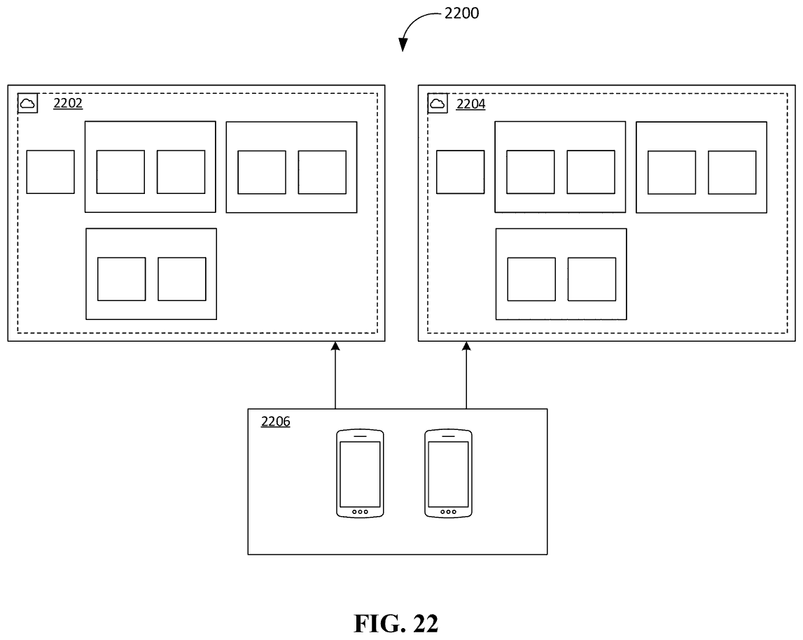

FIG. 22 is a block diagram of a system 2200 for facilitating managing of toll systems, in accordance with some embodiments. Accordingly, the system 2200 may be configured for deploying instances of a platform (or the software platform) for each client. Further, the system 2200 may be associated with a first instance 2202 of the platform for a first client. Further, the system 2200 may be associated with a second instance 2204 of the platform for a second client. Further, the first instance 2202 and the second instance 2204 may be associated with test probes 2206. For example, one client's instance has separate databases and there is no connection between another client's instance and its database. An instance's web application and application backend are isolated from those of other instances. The mobile app supports logging into any instance and only one instance at a time. The mobile app does not share information between instances and does not save the data onto the phone.

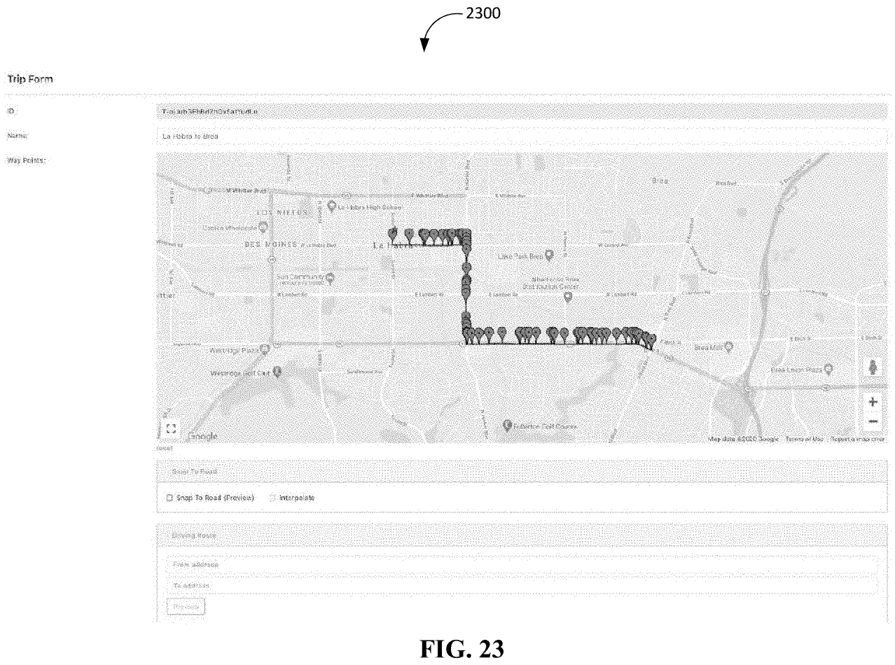

FIG. 23 is a screenshot 2300 of a user interface of the software platform associated with the disclosed system for facilitating auditing tolling associated with routes, in accordance with some embodiments.

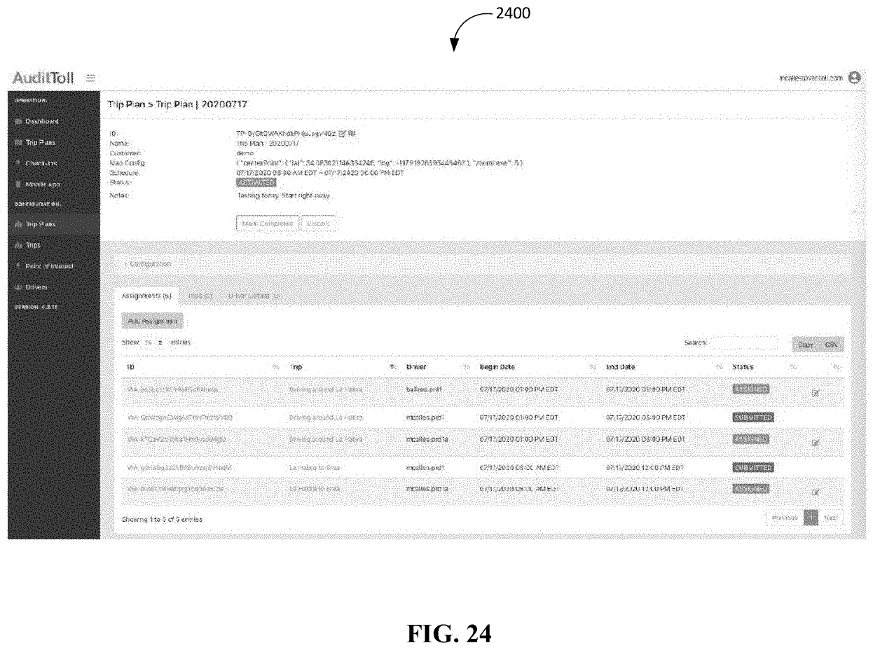

FIG. 24 is a screenshot 2400 of a user interface of the software platform associated with the disclosed system for facilitating auditing tolling associated with routes, in accordance with some embodiments.

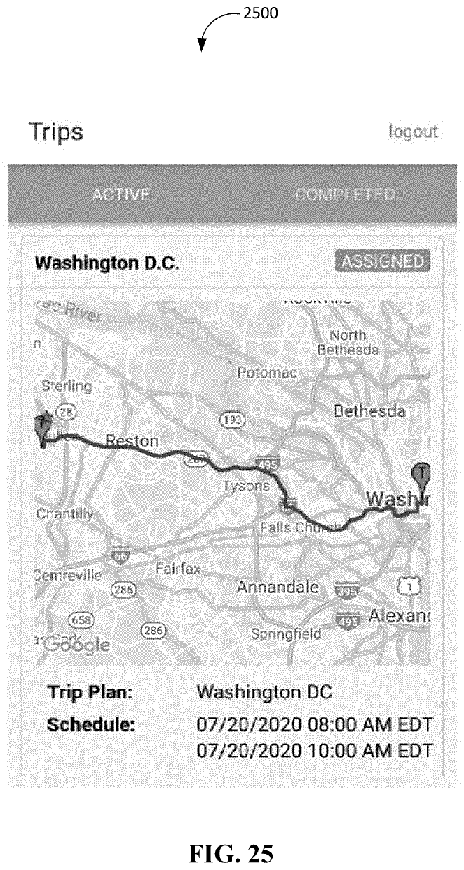

FIG. 25 is a screenshot 2500 of a user interface of the software platform associated with the disclosed system for facilitating auditing tolling associated with routes, in accordance with some embodiments.

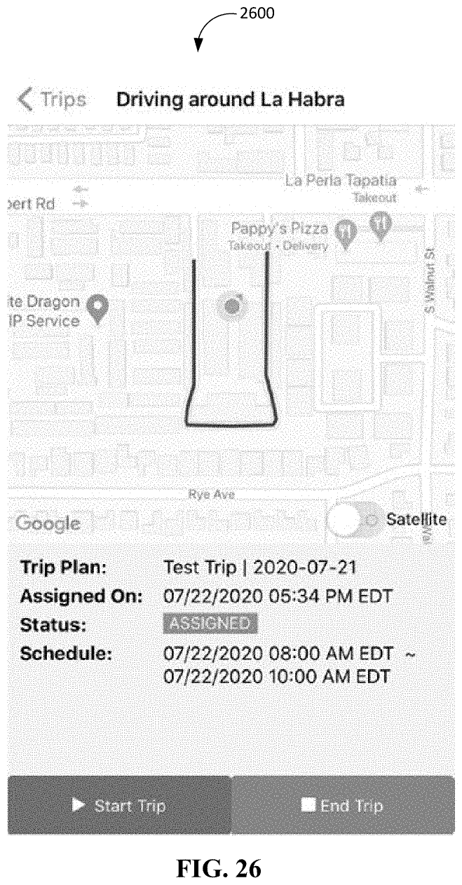

FIG. 26 is a screenshot 2600 of a user interface of the software platform associated with the disclosed system for facilitating auditing tolling associated with routes, in accordance with some embodiments.

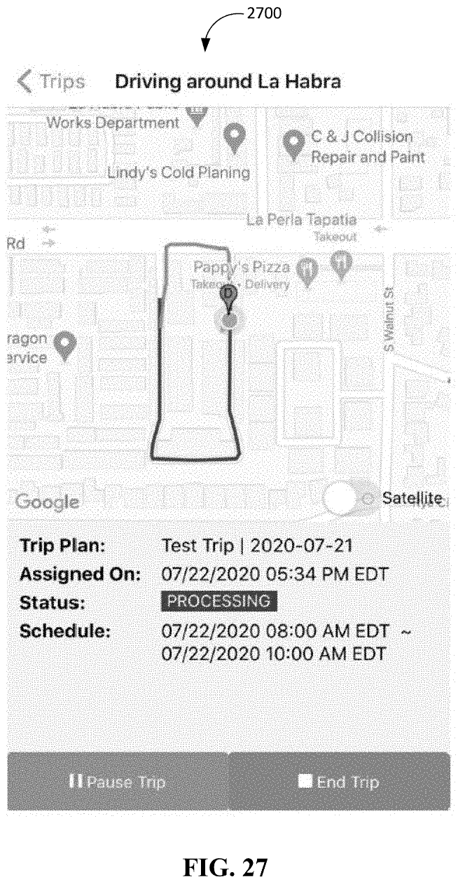

FIG. 27 is a screenshot 2700 of a user interface of the software platform associated with the disclosed system for facilitating auditing tolling associated with routes, in accordance with some embodiments.

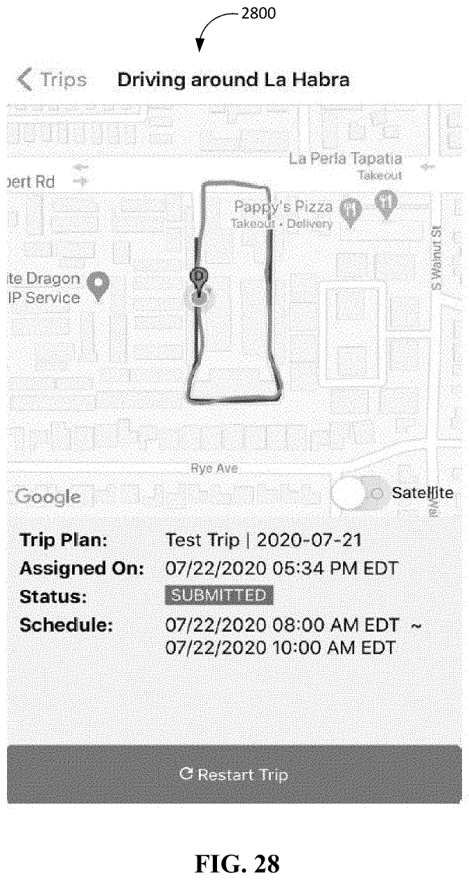

FIG. 28 is a screenshot 2800 of a user interface of the software platform associated with the disclosed system for facilitating auditing tolling associated with routes, in accordance with some embodiments.

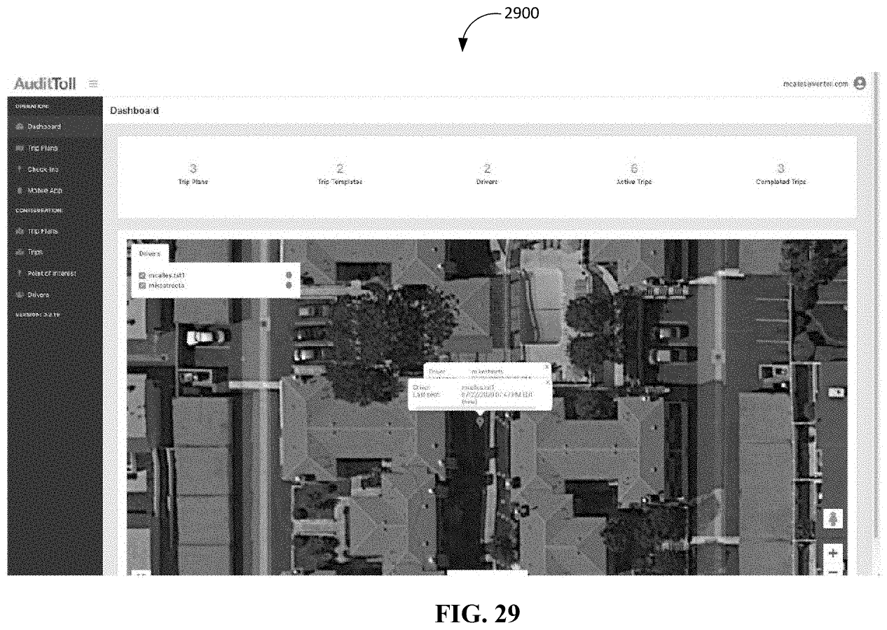

FIG. 29 is a screenshot 2900 of a user interface of the software platform associated with the disclosed system for facilitating auditing tolling associated with routes, in accordance with some embodiments.

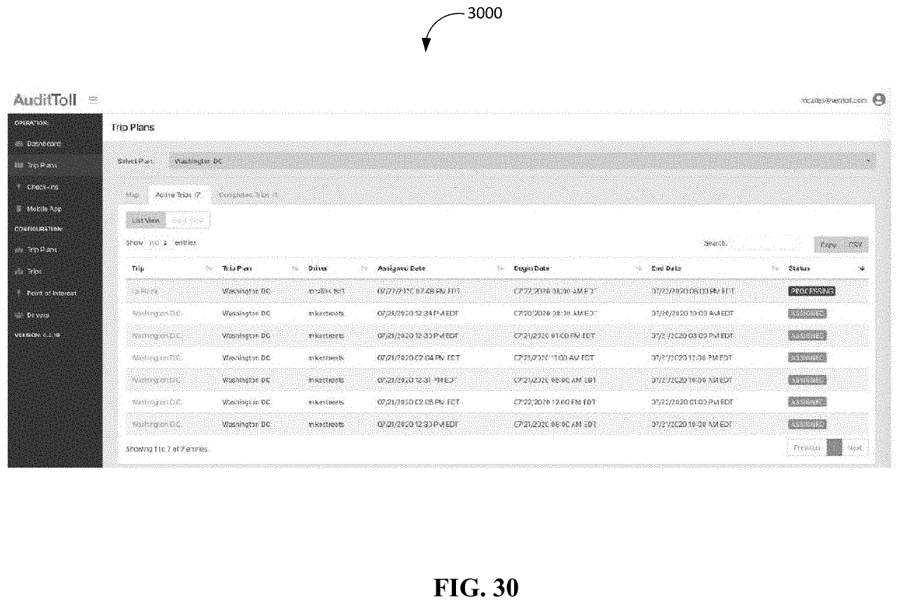

FIG. 30 is a screenshot 3000 of a user interface of the software platform associated with the disclosed system for facilitating auditing tolling associated with routes, in accordance with some embodiments.

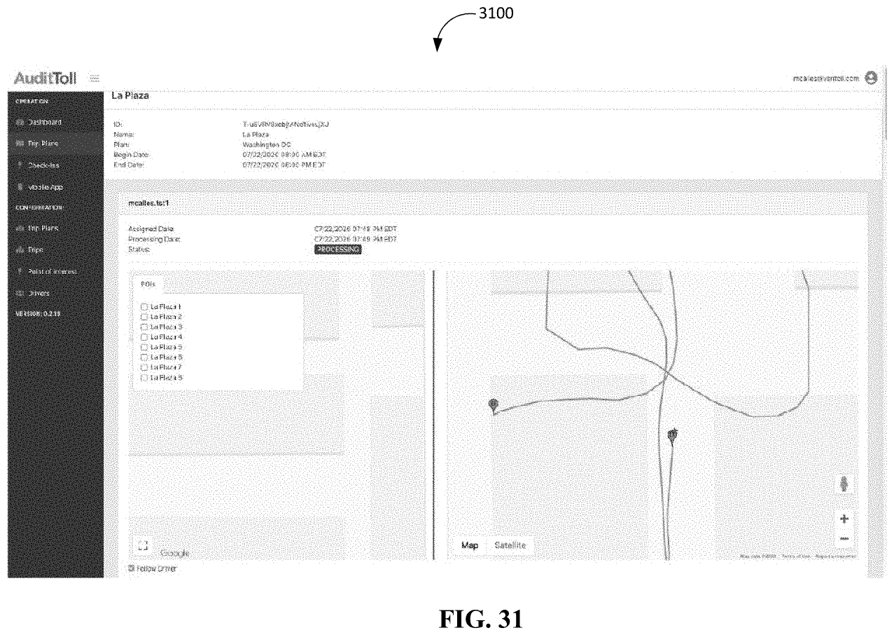

FIG. 31 is a screenshot 3100 of a user interface of the software platform associated with the disclosed system for facilitating auditing tolling associated with routes, in accordance with some embodiments.

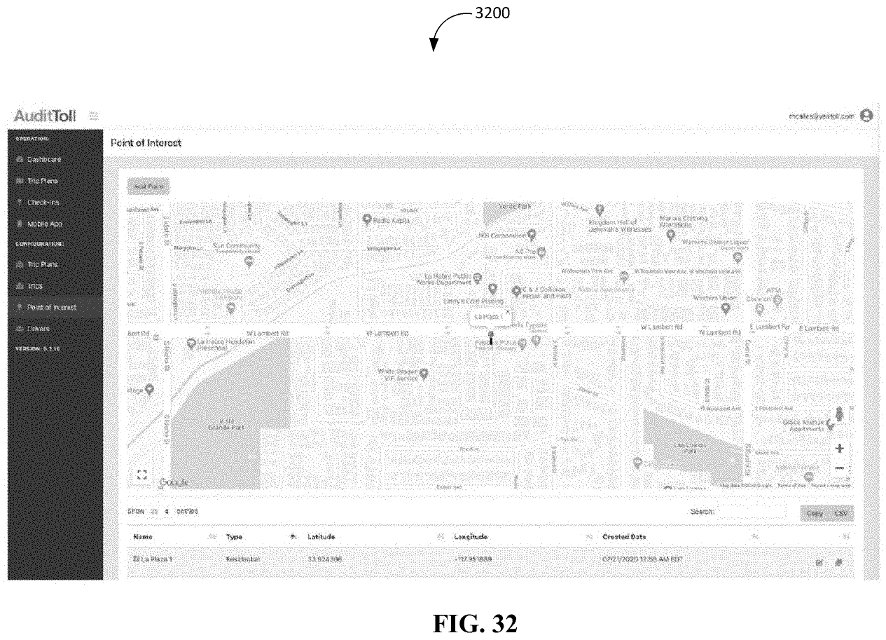

FIG. 32 is a screenshot 3200 of a user interface of the software platform associated with the disclosed system for facilitating auditing tolling associated with routes, in accordance with some embodiments.

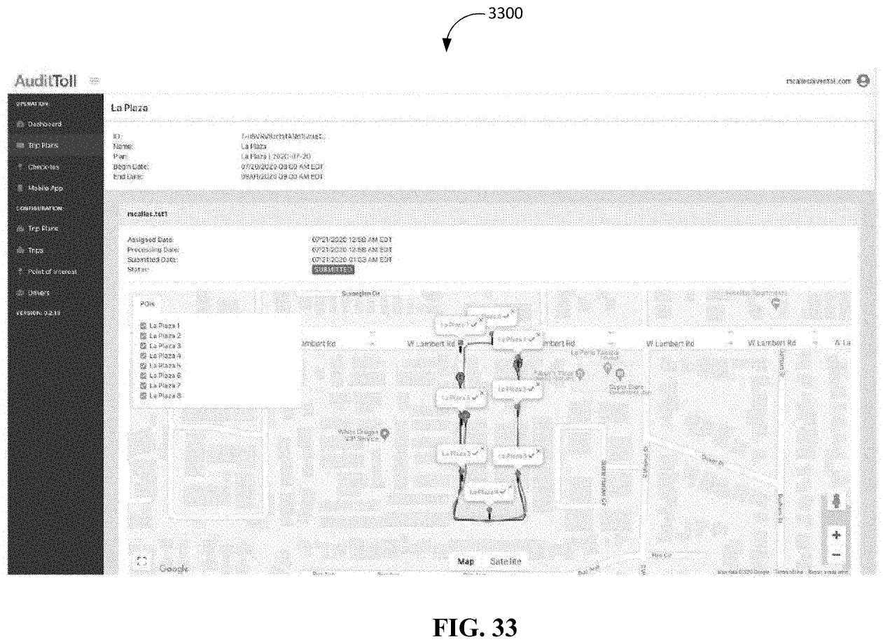

FIG. 33 is a screenshot 3300 of a user interface of the software platform associated with the disclosed system for facilitating auditing tolling associated with routes, in accordance with some embodiments.

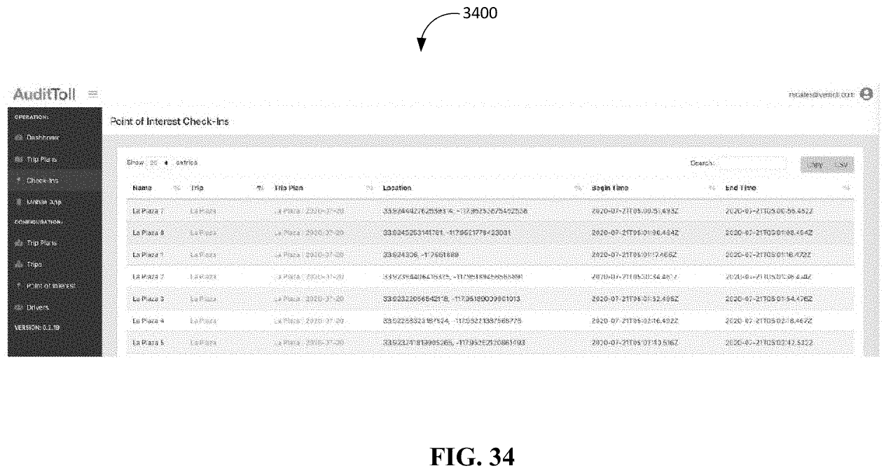

FIG. 34 is a screenshot 3400 of a user interface of the software platform associated with the disclosed system for facilitating auditing tolling associated with routes, in accordance with some embodiments.

Although the present disclosure has been explained in relation to its preferred embodiment, it is to be understood that many other possible modifications and variations can be made without departing from the spirit and scope of the disclosure.

We claim:

1. A method for facilitating auditing tolling associated with routes, the method comprising:
receiving, using a communication device, at least one request associated with at least one trip from at least one user device associated with at least one user, wherein the at least one request comprises at least one user identifier associated with the at least one user;
receiving, using the communication device, at least one vehicle data from at least one vehicle device associated with at least one vehicle used by the at least one user for making the at least one trip using at least one route, wherein the at least one vehicle data comprises at least one vehicle identifier associated with the at least one vehicle;
analyzing, using a processing device, the at least one vehicle data;
verifying, using the processing device, the at least one vehicle for the at least one trip based on the analyzing of the at least one vehicle data;
identifying, using the processing device, the at least one route for auditing the tolling based on the verifying of the at least one vehicle and the at least one request, wherein the at least one user drives the at least one vehicle on the at least one route for auditing the tolling associated with the at least one route during the at least one trip;
retrieving, using a storage device, at least one toll pricing sign information of at least one toll pricing sign displayed on the at least one route based on the identifying;
transmitting, using the communication device, the at least one toll pricing sign information to the at least one user device;
receiving, using the communication device, at least one response corresponding to the at least one toll pricing sign encountered by the at least one user while driving the at least one vehicle on the at least one route during the at least one trip from the at least one user device;
generating, using the processing device, at least one audit data of the at least one route based on the at least one user identifier, the at least one vehicle data, the at least one route, the at least one response, and the at least one toll pricing information; and
storing, using the storage device, the at least one audit data of the at least one route.

2. The method of claim 1, wherein the at least one vehicle device comprises at least one location sensor, wherein the at least one location sensor is configured for generating at least one location data based on detecting a location of the at least one vehicle and a time corresponding to the location during the at least one trip, wherein the at least one vehicle data further comprises the at least one location data.

3. The method of claim 1 further comprising:
retrieving, using the storage device, one or more vehicle data associated with one or more vehicles used by one or more users for making one or more trips, wherein the one or more vehicle data comprises one or more turn-by-turn directions made by the one or more vehicles during the one or more trips;
receiving, using the communication device, at least one route indication associated with at least one route from at least one first user device;
analyzing, using the processing device, the one or more vehicle data and the at least one route indication;
generating, using the processing device, the at least one route based on the analyzing of the one or more vehicle data and the at least one route indication; and
storing, using the storage device, the at least one route.

4. The method of claim 1 further comprising:
retrieving, using the storage device, at least one point of interest (POI) information associated with at least one point of interest (POI) present on the at least one route based on the identifying of the at least one route;
analyzing, using the processing device, the at least one POI information and the at least one audit data;
determining, using the processing device, at least one of at least one indication of passing the at least one POI and at least one time window during the at least one POI is passed by the at least one vehicle based on the analyzing of the at least one POI information and the at least one audit data; and
transmitting, using the communication device, at least one of the at least one indication of the passing of the at least one POI and the at least one time window during the at least one POI is passed to at least one third user device.

5. The method of claim 4 further comprising:
analyzing, using the processing device, at least one of the at least one indication of passing the at least one POI and the at least one time window during the at least one POI is passed by the at least one vehicle based on the determining of at least one of the at least one indication and the at least one time window;
generating, using the processing device, a health of the at least one POI based on the analyzing of at least one of the at least one indication and the at least one time window; and
transmitting, using the communication device, the health to the at least one third user device.

6. The method of claim 1 further comprising:
receiving, using the communication device, at least one specific route indication associated with at least one specific route from at least one second user device;
identifying, using the processing device, the at least one specific route based on the at least one specific route indication;
retrieving, using the storage device, at least one specific audit data associated with the at least one specific route based on the identifying of the at least one specific route; and
transmitting, using the communication device, the at least one specific audit data to the at least one second user device.

7. The method of claim 6 further comprising:
analyzing, using the processing device, the at least one specific audit data;
identifying, using the processing device, at least one specific user driving at least one specific vehicle on the at least one specific route based on the analyzing of the at least one specific audit data and the identifying of the at least one specific route;
determining, using the processing device, at least one incentive for the at least one specific user based on the identifying of the at least one specific user; and
transmitting, using the communication device, the at least one incentive to at least one specific user device associated with the at least one specific user.

8. The method of claim 1 further comprising:
retrieving, using the storage device, at least toll data associated with at least one tolling agency tolling the at least one route based on the identifying of the at least one route;
comparing, using the processing device, the at least one toll data and the at least one audit data;
determining, using the processing device, a discrepancy between the at least one toll data and the at least one audit data based on the comparing;
generating, using the processing device, a discrepancy report based on the determining of the discrepancy; and
transmitting, using the communication device, the discrepancy report to at least one tolling agency device associated with the at least one tolling agency.

9. The method of claim 1, wherein the at least one user device comprises at least one image sensor, wherein the at least one image sensor is configured for generating at least one toll pricing sign image of the at least one toll pricing sign based on capturing the at least one toll pricing sign, wherein the at least one response comprises the at least one toll pricing sign image.

10. The method of claim 1, wherein the at least one vehicle data comprises at least one of a license plate information associated with the at least one vehicle, a vehicle identification information associated with the at least one vehicle, a vehicle model information associated with the at least one vehicle, a vehicle make information associated with the at least one vehicle, and a vehicle device identification information associated with the at least one vehicle device.

11. A system for facilitating auditing tolling associated with routes, the system comprising:
a communication device configured for:
receiving at least one request associated with at least one trip from at least one user device associated with at least one user, wherein the at least one request comprises at least one user identifier associated with the at least one user;
receiving at least one vehicle data from at least one vehicle device associated with at least one vehicle used by the at least one user for making the at least one trip using at least one route, wherein the at least one vehicle data comprises at least one vehicle identifier associated with the at least one vehicle;
transmitting at least one toll pricing sign information to the at least one user device; and
receiving at least one response corresponding to at least one toll pricing sign encountered by the at least one user while driving the at least one vehicle on the at least one route during the at least one trip from the at least one user device;
a processing device communicatively coupled with the communication device, wherein the processing device is configured for:
analyzing the at least one vehicle data;
verifying the at least one vehicle for the at least one trip based on the analyzing of the at least one vehicle data;
identifying the at least one route for auditing the tolling based on the verifying of the at least one vehicle and the at least one request, wherein the at least one user drives the at least one vehicle on the at least one route for auditing the tolling associated with the at least one route during the at least one trip; and
generating at least one audit data of the at least one route based on the at least one user identifier, the at least one vehicle data, the at least one route, the at least one response, and the at least one toll pricing information; and
a storage device communicatively coupled with the processing device, wherein the storage device is configured for:
retrieving the at least one toll pricing sign information of the at least one toll pricing sign displayed on the at least one route based on the identifying; and
storing the at least one audit data of the at least one route.

12. The system of claim 11, wherein the at least one vehicle device comprises at least one location sensor, wherein the at least one location sensor is configured for generating at least one location data based on detecting a location of the at least one vehicle and a time corresponding to the location during the at least one trip, wherein the at least one vehicle data further comprises the at least one location data.

13. The system of claim 11, wherein the storage device is further configured for:
retrieving one or more vehicle data associated with one or more vehicles used by one or more users for making one or more trips, wherein the one or more vehicle data comprises one or more turn-by-turn directions made by the one or more vehicles during the one or more trips; and
storing the at least one route, wherein the communication device is further configured for receiving at least one route indication associated with at least one route from at least one first user device, wherein the processing device is further configured for:
analyzing the one or more vehicle data and the at least one route indication; and
generating the at least one route based on the analyzing of the one or more vehicle data and the at least one route indication.

14. The system of claim 11, wherein the storage device is further configured for retrieving at least one point of interest (POI) information associated with at least one point of interest (POI) present on the at least one route based on the identifying of the at least one route, wherein the processing device is configured for:
analyzing the at least one POI information and the at least one audit data; and
determining at least one of at least one indication of passing the at least one POI and at least one time window during the at least one POI is passed by the at least one vehicle based on the analyzing of the at least one POI information and the at least one audit data, wherein the communication device is further configured for transmitting at least one of the at least one indication of the passing of the at least one POI and the at least one time window during the at least one POI is passed to at least one third user device.

15. The system of claim 14, wherein the processing device is further configured for:
analyzing at least one of the at least one indication of passing the at least one POI and the at least one time window during the at least one POI is passed by the at least one vehicle based on the determining of at least one of the at least one indication and the at least one time window; and
generating a health of the at least one POI based on the analyzing of at least one of the at least one indication and the at least one time window, wherein the communication device is further configured for transmitting the health to the at least one third user device.

16. The system of claim 11, wherein the communication device is further configured for:
receiving at least one specific route indication associated with at least one specific route from at least one second user device; and
transmitting at least one specific audit data to the at least one second user device, wherein the processing device is further configured for identifying the at least one specific route based on the at least one specific route indication, wherein the storage device is further configured for retrieving the at least one specific audit data associated with the at least one specific route based on the identifying of the at least one specific route.

17. The system of claim 16, wherein the processing device is further configured for:
analyzing the at least one specific audit data;
identifying at least one specific user driving at least one specific vehicle on the at least one specific route based on the analyzing of the at least one specific audit data and the identifying of the at least one specific route; and
determining at least one incentive for the at least one specific user based on the identifying of the at least one specific user, wherein the communication device is further configured for transmitting the at least one incentive to at least one specific user device associated with the at least one specific user.

18. The system of claim 11, wherein the storage device is further configured for retrieving at least toll data associated with at least one tolling agency tolling the at least one route based on the identifying of the at least one route, wherein the processing device is further configured for:
comparing the at least one toll data and the at least one audit data;
determining a discrepancy between the at least one toll data and the at least one audit data based on the comparing; and
generating a discrepancy report based on the determining of the discrepancy, wherein the communication device is further configured for transmitting the discrepancy report to at least one tolling agency device associated with the at least one tolling agency.

19. The system of claim 11, wherein the at least one user device comprises at least one image sensor, wherein the at least one image sensor is configured for generating at least one toll pricing sign image of the at least one toll pricing sign based on capturing the at least one toll pricing sign, wherein the at least one response comprises the at least one toll pricing sign image.

20. The system of claim 11, wherein the at least one vehicle data comprises at least one of a license plate information associated with the at least one vehicle, a vehicle identification information associated with the at least one vehicle, a vehicle model information associated with the at least one vehicle, a vehicle make information associated with the at least one vehicle, and a vehicle device identification information associated with the at least one vehicle device.
